(19) United States
(12) Patent Application Publication
(10) Pub. No.: US 2010/0067512 A1
(43) Pub. Date: Mar. 18, 2010

(54) Uplink transmit diversity schemes with 4 antenna ports

(75) Inventors: Young-Han Nam, Plano, TX (US); Jianzhong Zhang, Irving, TX (US)

Correspondence Address: Docket Clerk, P.O. Drawer 800889, Dallas, TX, 75380, US

(73) Assignee: Samsung Electronics Co., Ltd., Suwon-si (KR)

(21) Appl. No.: 12/387,098

(22) Filed: Apr. 27, 2009

Related U.S. Application Data
(60) Provisional application No. 61/097,824, filed on Sep. 17, 2008.

(51) Int. Cl. H04B 7/216; H04L 27/00; H04B 1/38; H04B 7/02

(52) U.S. Cl. 370/342; 375/295; 375/219; 375/267

(57) ABSTRACT

A system and method for uplink transmit diversity. The system and method include a pairing device configured to pair a number of symbol sets to form paired sets. The paired sets are mapped onto a number of layers. The layers are precoded into at least two pairs of two precoded streams and the precoded streams are mapped onto at least two antenna ports. Further, a number demodulation reference signals are transmitted via a portion of the resource elements for at least two antenna ports such that, a first number of demodulation reference signals are transmitted via a portion of the resource elements of a first pair of antenna ports and a second number of demodulation reference signals are transmitted via a portion of the resource elements of the second pair of antenna ports.

### CROSS-REFERENCE TO RELATED APPLICATION(S) AND CLAIM OF PRIORITY

The present application is related to U.S. Provisional Patent No. 61/097,824, filed Sep. 17, 2008, entitled “UPLINK TRANSMIT DIVERSITY SCHEMES WITH 4 ANTENNA PORTS”. Provisional Patent No. 61/097,824 is assigned to the assignee of the present application and is hereby incorporated by reference into the present application as if fully set forth herein. The present application hereby claims priority under 35 U.S.C. §119(e) to U.S. Provisional Patent No. 61/097,824.

### TECHNICAL FIELD OF THE INVENTION

The present application relates generally to wireless communications networks and, more specifically, to diversity schemes for a wireless communication network.

### BACKGROUND OF THE INVENTION

Modern communications demand higher data rates and performance. Multiple input, multiple output (MIMO) antenna systems, also known as multiple-element antenna (MEA) systems, achieve greater spectral efficiency for allocated radio frequency (RF) channel bandwidths by utilizing space or antenna diversity at both the transmitter and the receiver, or in other cases, the transceiver.

In MIMO systems, each of a plurality of data streams is individually mapped and modulated before being precoded and transmitted by different physical antennas or effective antennas. The combined data streams are then received at multiple antennas of a receiver. At the receiver, each data stream is separated and extracted from the combined signal. This process is generally performed using a minimum mean squared error (MMSE) or MMSE-successive interference cancellation (SIC) algorithm.

### SUMMARY OF THE INVENTION

A subscriber station capable of diversity transmissions is provided. The subscriber station includes a pairing device. The pairing device is configured to pair a number of symbol sets to form a number of paired sets such that a first symbol set with a second symbol set to form a paired set. The subscriber station includes a layer mapper. The layer mapper is configured to map the number of paired sets onto a number of layers. The subscriber station also includes a transmit diversity precoder configured to precode the number of layers into at least two pairs of two precoded streams. Further, the subscriber station includes a resource element mapper configured to map each pair of the precoded streams onto at least two antenna ports.

A subscriber station capable of diversity transmissions is provided. The subscriber station includes a dual carrier transmitter. The dual carrier transmitter includes a modulation device, a precoding device, and a pairing device. The pairing device is configured to pair a number of symbols sets to form at least one paired set such that a first symbol set with a second symbol set to form the at least one paired set. The dual carrier also includes a layer mapper configured to map the a number of paired sets onto a number of layers; a transmit diversity precoder configured to precode the number of layers into at least two pairs of two precoded streams; and a resource element mapper configured to map each of the precoded streams onto at least two antenna ports.

A method transmitting demodulation reference signals is provided. The method includes transmitting a number demodulation reference signals via a portion of a number of resource elements for at least two antenna ports. A first number of demodulation reference signals are transmitted via a portion of the resource elements of a first pair of antenna ports and a second number of demodulation reference signals are transmitted via a portion of the resource elements of the second pair of antenna ports.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an Orthogonal Frequency Division Multiple Access (OFDMA) wireless network that is capable of decoding data streams according to one embodiment of the present disclosure;

FIG. 2A is a high-level diagram of an OFDMA transmitter according to one embodiment of the present disclosure;

FIG. 2B is a high-level diagram of an OFDMA receiver according to one embodiment of the present disclosure;

FIG. 3A illustrates details of the LTE downlink (DL) physical channel processing according to an embodiment of the present disclosure;

FIG. 3B illustrates details of the LTE uplink (UL) physical channel processing according to an embodiment of the present disclosure;

FIG. 3C illustrates an UL resource grid according to embodiments of the present disclosure;

FIG. 3D illustrates UL subframe structures in LTE according to embodiments of the present disclosure;

FIG. 4 illustrates details of the layer mapper and precoder of FIG. 3A according to one embodiment of the present disclosure;

FIG. 5 illustrates details of another layer mapper and precoder of FIG. 3 according to one embodiment of the present disclosure;

FIG. 6 illustrates details of an Alamouti STBC with SC-FDMA precoder according to one embodiment of the present disclosure;

FIG. 7 illustrates a transmitter structure for 4-TxD schemes according to one embodiment of the present disclosure;

FIG. 8 illustrates a partition of a block of symbols to be input to a DFT precoder according to embodiments of the present disclosure;

FIG. 9 illustrates a detailed view of the transmitter components for paired symbols according to one embodiment of the present disclosure;

FIG. 10 illustrates a pairing operation according to embodiments of the present disclosure;

FIG. 11 illustrates a layer mapping operation according to embodiments of the present disclosure;

FIG. 12 illustrates a top-down split layer mapping method according to embodiments of the present disclosure;

FIG. 13 illustrates an even-odd split layer mapping method according to embodiments of the present disclosure;

FIG. 14 illustrates a top-down split TxD preceding method according to embodiments of the present disclosure;

FIG. 15 illustrates an even-odd split TxD preceding method according to embodiments of the present disclosure;

FIGS. 16A and 16B illustrate a no-paired TxD preceding methods according to embodiments of the present disclosure;

FIG. 17 illustrates a transmitter structure for 4-TxD schemes in the SC-FDMA UL with explicit dual carriers (hereinafter “dual carrier transmitter”) according to embodiments of the present disclosure;

FIG. 18 illustrates a detailed view of the dual carrier transmitter components for one stream of symbols according to one embodiment of the present disclosure;

FIG. 19 illustrates a DM-RS mapping method according to embodiments of the present disclosure;

FIG. 20 illustrates another DM-RS mapping method according to embodiments of the present disclosure; and

FIG. 21 illustrates another DM-RS mapping method according to embodiments of the present disclosure.

### DETAILED DESCRIPTION OF THE INVENTION

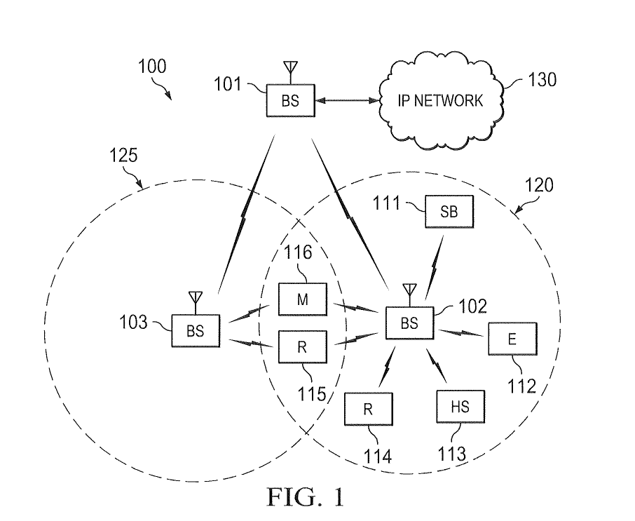

FIGS. 1 through 21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications network.

With regard to the following description, it is noted that the 3GPP Long Term Evolution (LTE) term “node B” is another term for “base station” used below. Also, the LTE term “user equipment” or “UE” is another term for “subscriber station” used below.

FIG. 1 illustrates exemplary wireless network 100 that is capable of decoding data streams according to one embodiment of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. Subscriber station (SS) may be any wireless communication device, such as, but not limited to, a mobile phone, mobile PDA and any mobile station (MS). In an exemplary embodiment, SS 111 may be located in a small business (SB), SS 112 may be located in an enterprise (E), SS 113 may be located in a WiFi hotspot (HS), SS 114 may be located in a first residence, SS 115 may be located in a second residence, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116. In alternate embodiments, base stations 102 and 103 may be connected directly to the Internet by means of a wired broadband connection, such as an optical fiber, DSL, cable or T1/E1 line, rather than indirectly through base station 101.

In other embodiments, base station 101 may be in communication with either fewer or more base stations. Furthermore, while only six subscriber stations are shown in FIG. 1, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be operating in handoff mode, as known to those of skill in the art.

In an exemplary embodiment, base stations 101-103 may communicate with each other and with subscriber stations 111-116 using an IEEE-802.16 wireless metropolitan area network standard, such as, for example, an IEEE-802.16e standard. In another embodiment, however, a different wireless protocol may be employed, such as, for example, a HIPERMAN wireless metropolitan area network standard. Base station 101 may communicate through direct line-of-sight or non-line-of-sight with base station 102 and base station 103, depending on the technology used for the wireless backhaul. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, café, hotel, or college campus. Base station 102 may provide digital subscriber line (DSL) level service to subscriber stations 114, 115 and 116.

Subscriber stations 111-116 may use the broadband access to network 130 to access voice, data, video, video teleconferencing, and/or other broadband services. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer, a laptop computer, a gateway, or another device.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from less than 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively. In other embodiments, the use of directional antennas may locate the base station near the edge of the coverage area, for example, at the point of a cone-shaped or pear-shaped coverage area.

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. In the case of voice-based communications in the form of voice-over-IP (VoIP), the traffic may be forwarded directly to the Internet gateway instead of the PSTN gateway. The servers, Internet gateway, and public switched telephone network gateway are not shown in FIG. 1. In another embodiment, the connection to network 130 may be provided by different network nodes and equipment.

In accordance with an embodiment of the present disclosure, one or more of base stations 101-103 and/or one or more of subscriber stations 111-116 comprises a receiver that is operable to decode a plurality of data streams received as a combined data stream from a plurality of transmit antennas using an MMSE-SIC algorithm. As described in more detail below, the receiver is operable to determine a decoding order for the data streams based on a decoding prediction metric for each data stream that is calculated based on a strength-related characteristic of the data stream. Thus, in general, the receiver is able to decode the strongest data stream first, followed by the next strongest data stream, and so on. As a result, the decoding performance of the receiver is improved as compared to a receiver that decodes streams in a random or pre-determined order without being as complex as a receiver that searches all possible decoding orders to find the optimum order.

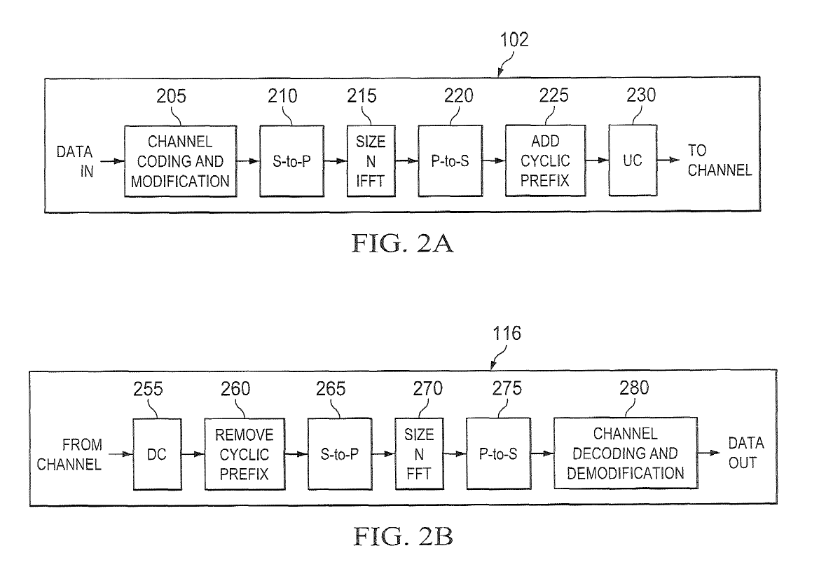

FIG. 2A is a high-level diagram of an orthogonal frequency division multiple access (OFDMA) transmit path. FIG. 2B is a high-level diagram of an orthogonal frequency division multiple access (OFDMA) receive path. In FIGS. 2A and 2B, the OFDMA transmit path is implemented in base station (BS) 102 and the OFDMA receive path is implemented in subscriber station (SS) 116 for the purposes of illustration and explanation only. However, it will be understood by those skilled in the art that the OFDMA receive path may also be implemented in BS 102 and the OFDMA transmit path may be implemented in SS 116.

The transmit path in BS 102 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. The receive path in SS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 102, channel coding and modulation block 205 receives a set of information bits, applies coding (e.g., Turbo coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

The present disclosure describes methods and systems to convey information relating to base station configuration to subscriber stations and, more specifically, to relaying base station antenna configuration to subscriber stations. This information can be conveyed through a plurality of methods, including placing antenna configuration into a quadrature-phase shift keying (QPSK) constellation (e.g., n-quadrature amplitude modulation (QAM) signal, wherein n is 2̂x) and placing antenna configuration into the error correction data (e.g., cyclic redundancy check (CRC) data). By encoding antenna information into either the QPSK constellation or the error correction data, the base stations 101-103 can convey base stations 101-103 antenna configuration without having to separately transmit antenna configuration. These systems and methods allow for the reduction of overhead while ensuring reliable communication between base stations 101-103 and a plurality of subscriber stations.

In some embodiments disclosed herein, data is transmitted using QAM. QAM is a modulation scheme which conveys data by modulating the amplitude of two carrier waves. These two waves are referred to as quadrature carriers, and are generally out of phase with each other by 90 degrees. QAM may be represented by a constellation that comprises 2̂x points, where x is an integer greater than 1. In the embodiments discussed herein, the constellations discussed will be four point constellations (4-QAM). In a 4-QAM constellation a 2 dimensional graph is represented with one point in each quadrant of the 2 dimensional graph. However, it is explicitly understood that the innovations discussed herein may be used with any modulation scheme with any number of points in the constellation. It is further understood that with constellations with more than four points additional information (e.g., reference power signal) relating to the configuration of the base stations 101-103 may be conveyed consistent with the disclosed systems and methods.

It is understood that the transmitter within base stations 101-103 performs a plurality of functions prior to actually transmitting data. In the 4-QAM embodiment, QAM modulated symbols are serial-to-parallel converted and input to an inverse fast Fourier transform (IFFT). At the output of the IFFT, N time-domain samples are obtained. In the disclosed embodiments, N refers to the IFFT/fast Fourier transform (FFT) size used by the OFDM system. The signal after IFFT is parallel-to-serial converted and a cyclic prefix (CP) is added to the signal sequence. The resulting sequence of samples is referred to as an OFDM symbol.

At the receiver within the subscriber station, this process is reversed, and the cyclic prefix is first removed. Then the signal is serial-to-parallel converted before being fed into the FFT. The output of the FFT is parallel-to-serial converted, and the resulting QAM modulation symbols are input to the QAM demodulator.

The total bandwidth in an OFDM system is divided into narrowband frequency units called subcarriers. The number of subcarriers is equal to the FFT/IFFT size N used in the system. In general, the number of subcarriers used for data is less than N because some subcarriers at the edge of the frequency spectrum are reserved as guard subcarriers. In general, no information is transmitted on guard subcarriers.

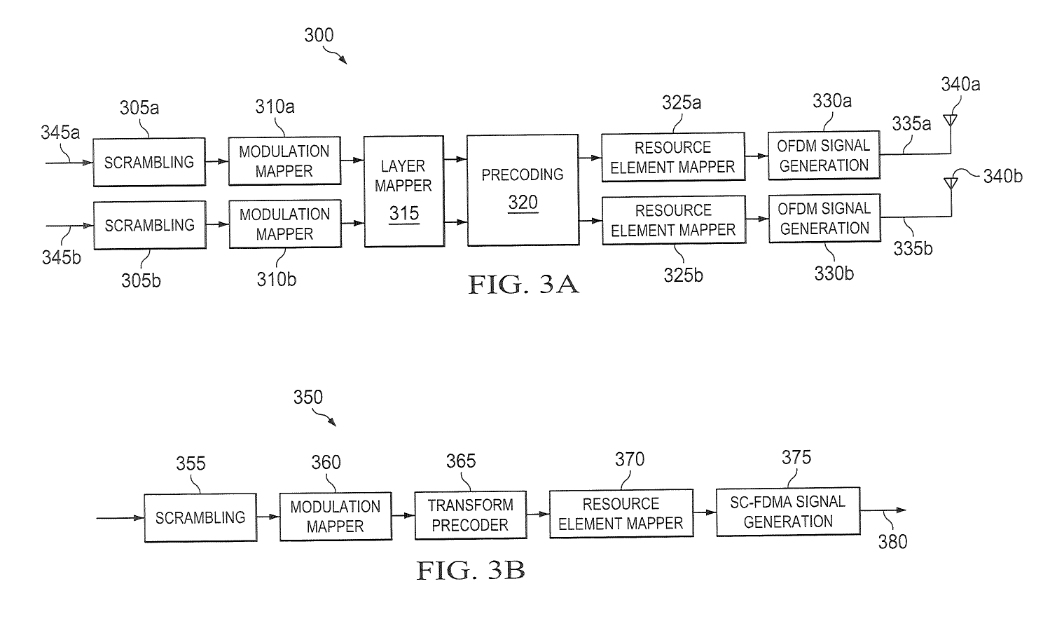

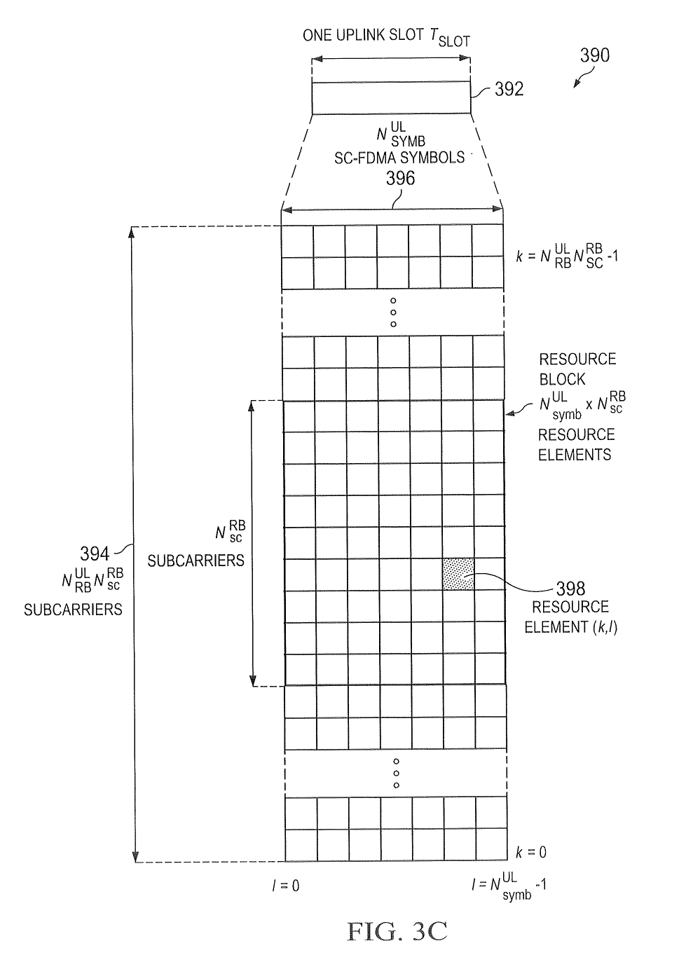

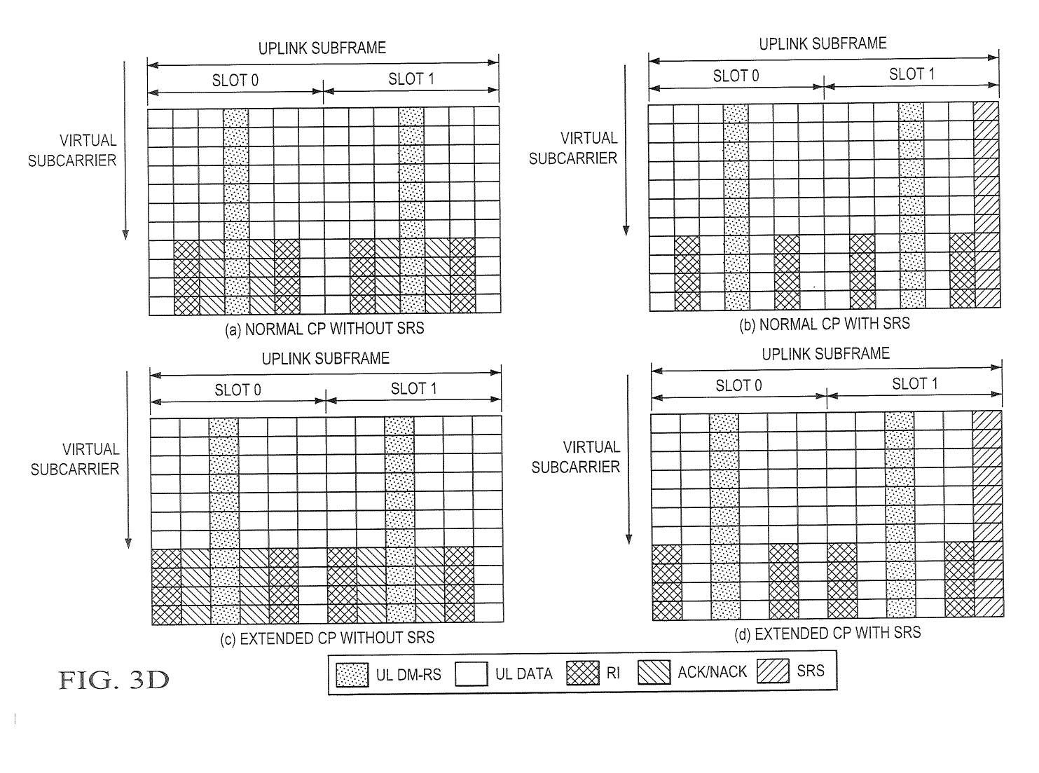

FIG. 3A illustrates details of the LTE downlink (DL) physical channel 300 processing according to an embodiment of the present disclosure. The embodiment of the DL physical channel 300 shown in FIG. 3A is for illustration only. Other embodiments of the DL physical channel 300 could be used without departing from the scope of this disclosure.

For this embodiment, physical channel 300 comprises a plurality of scrambler blocks 305, a plurality of modulation mapper blocks 310, a layer mapper 315, a preceding block 320 (hereinafter “precoding”), a plurality of resource element mappers 325, and a plurality of OFDM signal generation blocks 330. The embodiment of the DL physical channel 300 illustrated in FIG. 3A is applicable to more than one physical channel. Although the illustrated embodiment shows two sets of components 305, 310, 325 and 330 to generate two streams 335a-b for transmission by two antenna ports 3405a-b, it will be understood that physical channel 300 may comprise any suitable number of component sets 305, 310, 325 and 330 based on any suitable number of streams 335 to be generated.

The DL physical channel 300 is operable to scramble coded bits in each code word 345 to be transmitted on the DL physical channel 300. The plurality of scrambler blocks 305 are operable to scramble each code word 345a-345b according to Equation 1:

\tilde{b}^{q}(i)=(b^{q}(i)+c^{q}(i))mod 2. [Eqn: 1]

In Equation 1, b^{(q)}(0), . . . ,b^{(q)}(M_{bit}^{(q)}−1) is the block of bits for code word q, M_{bit}^{(q)} is the number of bits in code word q, and c^{q}(i) is the scrambling sequence.

The DL physical channel 300 further is operable to perform modulation of the scrambled bits. The plurality of modulation blocks 310 modulate the block of scrambled bits b^{(q)}(0), . . . ,b^{(q)}(M_{bit}^{(q)}−1). The block of scrambled bits b^{(q)}(0), . . . ,b^{(q)}(M_{bit}^{(q)}−1) is modulated using one of a number of modulation schemes including, quad phase shift keying (QPSK), sixteen quadrature amplitude modulation (16QAM), and sixty-four quadrature amplitude modulation (64QAM) for each of a physical downlink shared channel (PDSCH) and physical multicast channel (PMCH). Modulation of the scrambled bits by the plurality of modulation blocks 310 yields a block of complex-valued modulation symbols d^{(q)}(0), . . . ,d^{(q)}(M_{symb}^{(q)}−1).

Further, the DL physical channel 300 is operable to perform layer mapping of the modulation symbols. The layer mapper 315 maps the complex-valued modulation symbols d^{(q)}(0), . . . ,d^{(q)}(M_{symb}^{(q)}−1) onto one or more layers. Complex-valued modulation symbols d^{(q)}(0), . . . ,d^{(q)}(M_{symb}^{(q)}−1) for code word q are mapped onto one or more layers, x(i), as defined by Equation 2:

x(i)=[x⁽⁰⁾(i) . . . x^{(υ-1})(i)]^{T}. [Eqn. 2]

In Equation 2, i=0,1, . . . ,M_{symb}^{layer}−1, υ is the number of layers and M_{symb}^{layer} is the number of modulation symbols per layer.

For transmit diversity, the layer mapping 315 is performed according to Table 1.

TABLE 1
Code word-to-layer mapping for transmit diversity

| Number | Number of | Code word-to-layer | |
|---|---|---|---|
| of Layers | code words | mapping i = 0, 1, . . . , M_{symb}^{layer} − 1 | |
| 2 | 1 | x⁽⁰⁾ (i) = d⁽⁰⁾ (2i) | M_{symb}^{layer} = M_{symb}⁽⁰⁾/2 |
| | | x⁽¹⁾ (i) = d⁽⁰⁾ (2i + 1) | |
| 4 | 1 | x⁽⁰⁾ (i) = d⁽⁰⁾ (4i) | M_{symb}^{layer} = M_{symb}⁽⁰⁾/4 |
| | | x⁽¹⁾ (i) = d⁽⁰⁾ (4i + 1) | |
| | | x⁽²⁾ (i) = d⁽⁰⁾ (4i + 2) | |
| | | x⁽³⁾ (i) = d⁽⁰⁾ (4i + 3) | |

In Table 1, there is only one code word. Further, the number of layers υ is equal to the number of antenna ports P used for transmission of the DL physical channel 300.

Thereafter, preceding 320 is performed on the one or more layers. Precoding 320 is used for multi-layer beamforming in order to maximize the throughput performance of a multiple receive antenna system. The multiple streams of the signals are emitted from the transmit antennas with independent and appropriate weighting per each antenna such that the link through-put is maximized at the receiver output. Precoding algorithms for multi-codeword MIMO can be sub-divided into linear and nonlinear preceding types. Linear precoding approaches can achieve reasonable throughput performance with lower complexity relateved to nonlinear preceding approaches. Linear preceding includes unitary precoding and zero-forcing (hereinafter “ZF”) preceding. Nonlinear preceding can achieve near optimal capacity at the expense of complexity. Nonlinear precoding is designed based on the concept of Dirty paper coding (hereinafter “DPC”) which shows that any known interference at the transmitter can be subtracted without the penalty of radio resources if the optimal preceding scheme can be applied on the transmit signal.

Precoding 320 for transmit diversity is used only in combination with layer mapping 315 for transmit diversity, as described herein above. The preceding 320 operation for transmit diversity is defined for two and four antenna ports. The output of the preceding operation for two antenna ports (Pε{0,1}) is defined by Equations 3 and 4:

y(i)=[y⁽⁰⁾(i) y⁽¹⁾(i)]^{T}; [Eqn. 3]

where:

$$[ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ] = \frac{1}{\sqrt{2}} [ \begin{matrix}1 & 0 & j & 0 \\ 0 & - 1 & 0 & j \\ 0 & 1 & 0 & j \\ 1 & 0 & - j & 0\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ] , \qquad [ Eqn . 4 ]$$

for i=0,1, . . . ,M_{symb}^{layer}−1 with M_{symb}^{ap}=2M_{symb}^{layer}.

The output of the preceding operation for four antenna ports (Pε{0,1,2,3}) is defined by Equations 5 and 6:

y(i)=[y⁽⁰⁾(i) y⁽¹⁾(i) y⁽²⁾(i) y⁽³⁾(i)]^{T}, [Eqn. 5]

where:

$$[ \begin{matrix}{y}^{( 0 )} ( 4 i ) \\ {y}^{( 1 )} ( 4 i ) \\ {y}^{( 2 )} ( 4 i ) \\ {y}^{( 3 )} ( 4 i ) \\ {y}^{( 0 )} ( 4 i + 1 ) \\ {y}^{( 1 )} ( 4 i + 1 ) \\ {y}^{( 2 )} ( 4 i + 1 ) \\ {y}^{( 3 )} ( 4 i + 1 ) \\ {y}^{( 0 )} ( 4 i + 2 ) \\ {y}^{( 1 )} ( 4 i + 2 ) \\ {y}^{( 2 )} ( 4 i + 2 ) \\ {y}^{( 3 )} ( 4 i + 2 ) \\ {y}^{( 0 )} ( 4 i + 3 ) \\ {y}^{( 1 )} ( 4 i + 3 ) \\ {y}^{( 2 )} ( 4 i + 3 ) \\ {y}^{( 3 )} ( 4 i + 3 )\end{matrix} ] = \frac{1}{\sqrt{2}} [ \begin{matrix}1 & 0 & 0 & 0 & j & 0 & 0 & 0 \\ 0 & 0 & 0 & 0 & 0 & 0 & 0 & 0 \\ 0 & - 1 & 0 & 0 & 0 & j & 0 & 0 \\ 0 & 0 & 0 & 0 & 0 & 0 & 0 & 0 \\ 0 & 1 & 0 & 0 & 0 & j & 0 & 0 \\ 0 & 0 & 0 & 0 & 0 & 0 & 0 & 0 \\ 1 & 0 & 0 & 0 & - j & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 1 & 0 & 0 & 0 & j & 0 \\ 0 & 0 & 0 & 0 & 0 & 0 & 0 & 0 \\ 0 & 0 & 0 & - 1 & 0 & 0 & 0 & j \\ 0 & 0 & 0 & 0 & 0 & 0 & 0 & 0 \\ 0 & 0 & 0 & 1 & 0 & 0 & 0 & j \\ 0 & 0 & 0 & 0 & 0 & 0 & 0 & 0 \\ 0 & 0 & 1 & 0 & 0 & 0 & - j & 0\end{matrix} ] [ \begin{matrix}Re ( {x}^{( 0 )} ( i ) ) \\ Re ( {x}^{( 1 )} ( i ) ) \\ Re ( {x}^{( 2 )} ( i ) ) \\ Re ( {x}^{( 3 )} ( i ) ) \\ Im ( {x}^{( 0 )} ( i ) ) \\ Im ( {x}^{( 1 )} ( i ) ) \\ Im ( {x}^{( 2 )} ( i ) ) \\ Im ( {x}^{( 3 )} ( i ) )\end{matrix} ] , \qquad [ Eqn . 6 ]$$

for i=0,1, . . . ,M_{symb}^{layer}−1 with M_{symb}^{ap}=4M_{symb}^{layer}.

After preceding 320, the resource elements are mapped by the resource element mapper(s) 325. For each of the antenna ports 340 used for transmission of the DL physical channel 300, the block of complex-valued symbols y^{(p)}(0), . . . ,y^{(p)}(M_{symb}^{ap}−1) are mapped in sequence. The mapping sequence is started by mapping y^{(p)}(0) to resource elements (k,l) in physical resource blocks corresponding to virtual resource blocks assigned for transmission and not used for transmission of Physical Control Format Indicator Channel (PCFICH), Physical Hybrid Automatic Repeat Request Indicator Channel (PHICH), primary broadcast channel (PBCH), synchronization signals or reference signals. The mapping to resource elements (k, l) on antenna port (P) not reserved for other purposes shall be in increasing order of first the index k over the assigned physical resource blocks and then the index l, starting with the first slot in a subframe.

FIG. 3B illustrates details of the LTE uplink (UL) physical channel 350 processing according to an embodiment of the present disclosure. The embodiment of the UL physical channel 350 shown in FIG. 3B is for illustration only. Other embodiments of the UL physical channel 350 could be used without departing from the scope of this disclosure.

For this embodiment, a single-carrier frequency-dependent multiple access (SC-FDMA) is adopted as the basic transmission scheme. The UL physical channel 350 comprises a scrambling block 355, a modulation mapper 360, a transform precoder 365, a resource element mapper 370, and SC-FDMA signal generation block 375. The embodiment of the UL physical channel 350 illustrated in FIG. 3B is applicable to more than one UL physical channel. Although the illustrated embodiment shows one component 355, 360, 365, 370 and 375 to generate one streams 380 for transmission, will be understood that UL physical channel 350 may comprise any suitable number of component sets 355, 360, 365, 370 and 375 based on any suitable number of streams 380 to be generated. At least some of the components in FIGS. 3A and 3B may be implemented in software while other components may be implemented by configurable hardware or a mixture of software and configurable hardware.

The scrambling block 355 is operable to scramble coded bits to be transmitted on the UL physical channel 350. The UL physical channel 350 further is operable to perform modulation of the scrambled bits. The modulation block 360 modulates the block of scrambled bits \tilde{b}(0), . . . ,\tilde{b}(M_{bit}−1). The block of scrambled bits \tilde{b}(0), . . . ,\tilde{b}(M_{bit}−1) is modulated using one of a number of modulation schemes including, quad phase shift keying (QPSK), sixteen quadrature amplitude modulation (16QAM), and sixty-four quadrature amplitude modulation (64QAM) for each of a physical downlink shared channel (PDSCH) and physical multicast channel (PMCH). Modulation of the scrambled bits by the plurality of modulation blocks 310 yields a block of complex-valued modulation symbols d(0), . . . ,d(M_{symb}−1).

Thereafter, the UL physical channel 350 is operable to perform transform preceding on the block of complex-valued modulation symbols d(0), . . . ,d(M_{symb}−1). The transform precoder 365 divides the complex-valued modulation symbols, d(0), . . . ,d(M_{symb}−1), into M_{symb}/M_{sc}^{PUSCH} sets. Each set corresponds to one SC-FDMA symbol. Transform precoder 365 applies transform preceding using Equation 7:

$$z ( l \cdot {M}_{sc}^{PUSCH} + k ) = \frac{1}{\sqrt{{M}_{sc}^{PUSCH}}} {\sum }_{i = 0}^{{M}_{sc}^{PUSCH} - 1} d ( l \cdot {M}_{sc}^{PUSCH} + i ) {e}^{- j \frac{2 π k}{{M}_{sc}^{PUSCH}}} \\ k = 0 , … , {M}_{sc}^{PUSCH} - 1 \\ l = 0 , … , {M}_{symb} / {M}_{sc}^{PUSCH} - 1. \qquad [ Eqn . 7 ]$$

Using Equation 7 produces in a block of complex-valued symbols z(0), . . . ,z(M_{symb}−1). In Equation 7, the variable M_{sc}^{PUSCH}=M_{RB}^{PUSCH}·N_{sc}^{RB}, where M_{RB}^{PUSCH} represents the bandwidth of the PUSCH in terms of resource blocks. M_{RB}^{PUSCH} fulfills Equation 8:

M_{RB}^{PUSCH}=2^{α}^{₁}·3^{α}^{₃}·5^{α}^{₅}≦N_{RB}^{UL}. [Eqn. 8]

In Equation 8, α₂, α₃, and α₅ are a set of non-negative integers.

The resource element mapper 370 maps the complex-valued symbols z(0), . . . ,z(M_{symb}−1). The resource element mapper 370 multiplies the complex-valued symbols z(0), . . . ,z(M_{symb}−1) with an amplitude scaling factor β_{PUSCH}. The resource element mapper 370 maps the complex-valued symbols z(0), . . . ,z(M_{symb}−1) in sequence, starting with z(0), to physical resource blocks assigned for transmission of PUSCH. The mapping to resource elements (k,l) corresponding to the physical resource blocks assigned for transmission, and not used for transmission of reference signals, shall be in increasing order of: first the index k; then the index l; starting with the first slot in the subframe.

FIG. 3C illustrates an UL resource grid 390 according to embodiments of the present disclosure. The embodiment of the UL resource grid 390 shown in FIG. 3C is for illustration only. Other embodiments of the UL resource grid 390 could be used without departing from the scope of this disclosure.

The transmitted signal in each slot 392 is described by a resource grid of N_{RB}^{UL}N_{sc}^{RB} subcarriers 394 and N_{symb}^{UL} SC-FDMA symbols 396. Each element in the UL resource grid 390 is referred to as a resource element 398. Each resource element 398 is uniquely defined by an index pair (k,l) in a slot where k=0, . . . ,N_{RB}^{UL}N_{sc}^{RB}−1 and l=0, . . . ,N_{symb}^{UL}−1 are indices in the frequency and time domain, respectively. A resource element (k,l) 398 corresponds to a complex value a_{k,l}. The quantities of a_{k,l} corresponding to resource elements 398 not used for transmission of a physical channel or a physical signal in a slot are set to zero (0).

FIG. 3D illustrates UL subframe structures in LTE according to embodiments of the present disclosure. The embodiment of the subframe structures shown in FIG. 3D is for illustration only. Other embodiments of the subframe structure could be used without departing from the scope of this disclosure.

A UL subframe in an LTE system is composed of two time slots. Depending on the hopping configuration, the two slots in a subframe may or may not exist over the same set of subcarriers. A time slot is composed of a different number of SC-FDMA symbols in a normal cyclic-prefix (CP) slot and in an extended CP slot. A normal CP slot is composed of 7 SC-FDMA symbols, while an extended CP slot is composed of 6 SC-FDMA symbols. A slot has demodulation reference signals (DM-RS) in one symbol. At times, a sounding reference signal (SRS) is transmitted. In such cases, one SC-FDMA symbol in the second time slot in a subframe is reserved for the SRS in addition to the DM-RS. Embodiments of the present disclosure provide for four different combinations for the UL subframe structure, as illustrated in FIG. 3D, depending on the existence of SRS and normal/extended CPs. The number of data symbols in a time slot excluding reference symbols can be either even or odd, depending on the configuration. For example, as illustrated by FIG. 3D-(a), in the configuration of normal CP without SRS, the number of data symbol is six (6) for both slot 0 and slot 1. However, as illustrated by FIG. 3D-(d) in the configuration of extended CP with SRS, the number of data symbol is five (5) for slot 0, while the number is four (4) for slot 1.

A reference signal sequence, r_{u,v}^{(α)}(n), is defined by a cyclic shift α of a base sequence r̅_{u,v}(n) according to Equation 9:

r_{u,v}^{(α)}(n)=e^{jαn} r̅_{u,v}(n), 0≦n<M_{sc}^{RS} [Eqn. 9]

In Equation 9, M_{sc}^{RS}=mN_{sc}^{RB} is the length of the reference signal sequence and 1≦m≦N_{RB}^{max, UL}. Multiple reference signal sequences are defined from a single base sequence through different values of α. Base sequences r̅_{u,v}(n) are divided into groups, where u ε {0,1, . . . ,29} is the group number and v is the base sequence number within the group, such that each group contains one base sequence (v=0) of each length M_{sc}^{RS}=mN_{sc}^{RB}, 1≦m≦5 and two base sequences (v=0,1) of each length M_{sc}^{RS}=mN_{sc}^{RB}, and 6≦m≦N_{RB}^{max, UL}.

The demodulation reference signal sequence for PUSCH is defined by Equation 10:

$${r}^{PUSCH} ( m \cdot {M}_{sc}^{RS} + n ) = {r}_{u , v}^{( α )} ( n ) , \qquad [ Eqn . 10 ]$$

where m=0,1; n=0, . . . ,M_{sc}^{RS}−1; and M_{sc}^{RS}=M_{sc}^{PUSCH}.

The cyclic shift α in a slot is defined by Equation 11:

α=2πn_{cs}/12 [Eqn. 11]

In Equation 11, n_{cs} further is defined by Equation 12:

n_{cs}=(n_{DMRS}⁽¹⁾+n_{DMRS}⁽²⁾+n_{PRS})mod12 [Eqn. 12]

where n_{DMRS}⁽¹⁾ is a broadcasted value, n_{DMRS}⁽²⁾ is included in the uplink scheduling assignment and n_{PRS} is given by the pseudo-random sequence c(i) defined in section 7.2 in “3GPP TS 36211 V8.3.0, ‘3^{rd} Generation Partnership Project; Technical Specification Group Radio Access Network; Evolved Universal Terrestrial Radio Access (E-UTRA); Physical Channels and Modulation (Release 8)’, May 2008”, the contents of which are incorporated herein by reference. The application of c(i) is cell-specific. The values of n_{DMRS}⁽²⁾ are given in Table 2.

TABLE 2
Mapping of Cyclic Shift Field in DCI format 0 to n_{DMRS}⁽²⁾
Values.

| Cyclic Shift Field in | |
|---|---|
| DCI format 0 | n_{DMRS}⁽²⁾ |
| 000 | 0 |
| 001 | 2 |
| 010 | 3 |
| 011 | 4 |
| 100 | 6 |
| 101 | 8 |
| 110 | 9 |
| 111 | 10 |

The pseudo-random sequence generator is initialized at the beginning of each radio frame by Equation 13:

$${c}_{init} = ⌊ \frac{{N}_{ID}^{cell}}{30} ⌋ \cdot {2}^{5} + {f}_{ss}^{PUSCH} \qquad [ Eqn . 13 ]$$

FIG. 4 illustrates details of the layer mapper 315 and precoder 320 of FIG. 3A according to one embodiment of the present disclosure. The embodiment of the layer mapper 315 and precoder 320 shown in FIG. 4 is for illustration only. Other embodiments of the layer mapper 315 and precoder 320 could be used without departing from the scope of this disclosure.

In some embodiments, a two-layer transmit diversity (TxD) precoding scheme is the Alamouti scheme. In such embodiment, the precoder output is defined by Equation 14:

$$\begin{matrix}[ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ] = \frac{1}{\sqrt{2}} [ \begin{matrix}Re ( {x}^{( 0 )} ( i ) ) + j Im ( {x}^{( 0 )} ( i ) ) \\ - Re ( {x}^{( 1 )} ( i ) ) + j Im ( {x}^{( 1 )} ( i ) ) \\ Re ( {x}^{( 1 )} ( i ) ) + j Im ( {x}^{( 1 )} ( i ) ) \\ Re ( {x}^{( 0 )} ( i ) ) - j Im ( {x}^{( 0 )} ( i ) )\end{matrix} ] \\ = \frac{1}{\sqrt{2}} [ \begin{matrix}{x}^{( 0 )} ( i ) \\ - {( {x}^{( 1 )} ( i ) )}^{*} \\ {x}^{( 1 )} ( i ) \\ {( {x}^{( 0 )} ( i ) )}^{*}\end{matrix} ] .\end{matrix} \qquad [ Eqn . 14 ]$$

In Equation 14, ( )* denotes the complex conjugate and is equivalent to Equation 15:

$$[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 )\end{matrix} ] = \frac{1}{\sqrt{2}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*}\end{matrix} ] . \qquad [ Eqn . 15 ]$$

In Equation 15, the precoded signal matrix of the Alamouti scheme is denoted as X_{Alamouti}(i) as illustrated by Equation 16:

$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 )\end{matrix} ] = {X}_{Alamouti} ( i ) \\ ≡ \frac{1}{\sqrt{2}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*}\end{matrix} ] .\end{matrix} \qquad [ Eqn . 16 ]$$

The receiver algorithm for the Alamouti scheme can be efficiently designed by exploiting the orthogonal structure of the received signal. For example, for a receiver with one receive antenna, and denoting the channel gains between transmit (Tx) antenna (Tx layer) P and the receive antenna for i=0,1, . . . ,M_{symb}^{layer}−1 by h^{(p)}(i), a matrix equation for the relation between the received signal and the transmitted signal is defined by Equations 17 and 18:

$$\begin{matrix} r ( 2 i ) = \frac{1}{\sqrt{2}} [ \begin{matrix}{h}^{( 0 )} ( 2 i ) & {h}^{( 1 )} ( 2 i )\end{matrix} ] [ \begin{matrix}{x}^{( 0 )} ( i ) \\ - {( {x}^{( 1 )} ( i ) )}^{*}\end{matrix} ] + n ( 2 i ) . & [ Eqn . 17 a ] \\ r ( 2 i + 1 ) = \frac{1}{\sqrt{2}} [ \begin{matrix}{h}^{( 0 )} ( 2 i + 1 ) & {h}^{( 1 )} ( 2 i + 1 )\end{matrix} ] [ \begin{matrix}{x}^{( 1 )} ( i ) \\ {( {x}^{( 0 )} ( i ) )}^{*}\end{matrix} ] + n ( 2 i + 1 ) . & [ Eqn . 17 b ]\end{matrix}$$

In Equations 17a and 17b, r(2i) and r(2i+1) are the received signals and n(2i) and n(2i+1) are the received noises in the corresponding resource element. If h⁽⁰⁾(2i)=h⁽⁰⁾(2i+1) and h⁽¹⁾(2i)=h⁽¹⁾(2i+1), then Equations 17a and 17b can be rewritten as Equation 18, facilitating the detection of x⁽⁰⁾(i) and −(x⁽¹⁾(i))*:

$$[ \begin{matrix}r ( 2 i ) \\ {( r ( 2 i + 1 ) )}^{*}\end{matrix} ] = [ \begin{matrix}{h}^{( 0 )} ( 2 i ) & {h}^{( 1 )} ( 2 i ) \\ {( {h}^{( 1 )} ( 2 i ) )}^{*} & - {( {h}^{( 0 )} ( 2 i ) )}^{*}\end{matrix} ] [ \begin{matrix}{x}^{( 0 )} ( i ) \\ - {( {x}^{( 1 )} ( i ) )}^{*}\end{matrix} ] + [ \begin{matrix}{n}_{1} \\ {n}_{2}^{*}\end{matrix} ] \qquad [ Eqn . 18 ]$$

In order to detect x⁽⁰⁾(i), [(h⁽⁰⁾(2i))* h⁽¹⁾(2i)] is multiplied to both sides of Equation 11. Since the columns of the matrix in Equation 11 are orthogonal to each other, the multiplication results in the component of x⁽⁰⁾(i) becoming zero (0) in the equation. Thus, an interference-free detection for x⁽⁰⁾(i) can be done. Additionally, [(h⁽¹⁾(2i))* −h⁽⁰⁾(2i)] can be multiplied to both sides of Equation 11. Therefore, each symbol has been passed through two channel gains and the diversity is achieved for each pair of the symbols. Since the information stream is transmitted over antennas (space) and over different resource elements (either time or frequency), these schemes are referred to as Alamouti code space time-block code (STBC) or space frequency block code (SFBC).

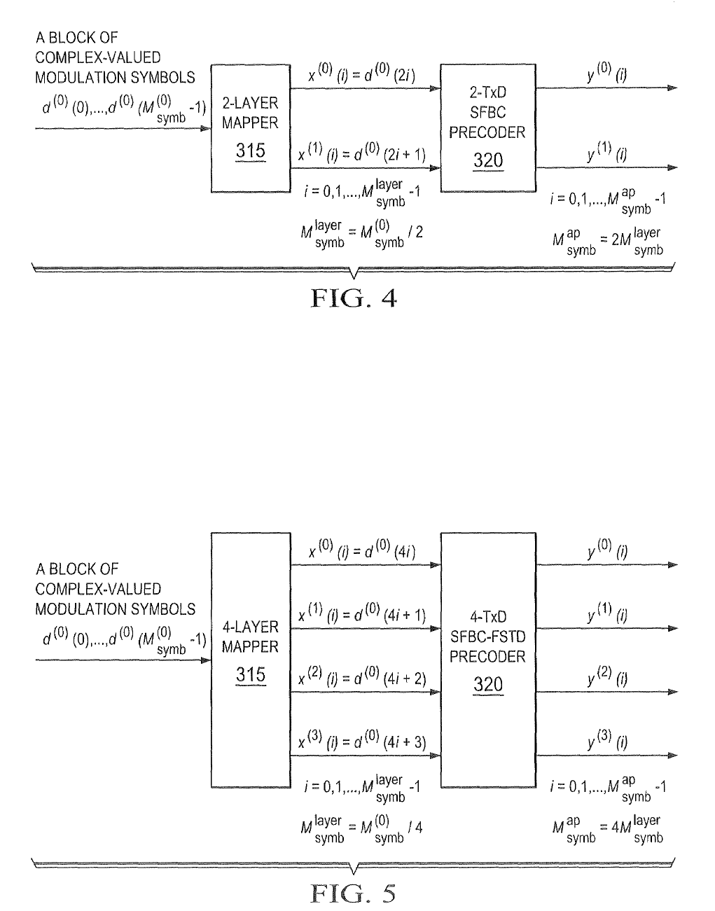

FIG. 5 illustrates details of another layer mapper 315 and precoder 320 of FIG. 3 according to one embodiment of the present disclosure. The embodiment of the layer mapper 315 and precoder 320 shown in FIG. 5 is for illustration only. Other embodiments of the layer mapper 315 and precoder 320 could be used without departing from the scope of this disclosure.

When 4-Tx antennas are available at the transmitter, the TxD schemes can include SFBC-FSTD (FSTD: frequency switch transmit diversity), SFBC-PSD (PSD: phase-shift diversity), quasi-orthogonal SFBC (QO-SFBC), SFBC-CDD (CDD: cyclic delay diversity) and balanced SFBC/FSTD. SFBC-FSTD refers to a TxD scheme utilizing Alamouti SFBC over 4-Tx antennas and 4 subcarriers in a block diagonal fashion. The relevant blocks in the block diagram showing the physical channel processing in LTE are drawn in detail in FIG. 5 for the four-layer TxD in LTE.

In one embodiment, the precoder 320 is a 4-layer TxD (or 4-TxD) SFBC-SFTD precoder. The precoded signal matrix over Tx antennas (rows) and over subcarriers (columns) for the SFBC-FSTD is defined by Equation 19:

$$[ \begin{matrix}{y}^{( 0 )} ( 4 i ) & {y}^{( 0 )} ( 4 i + 1 ) & {y}^{( 0 )} ( 4 i + 2 ) & {y}^{( 0 )} ( 4 i + 3 ) \\ {y}^{( 1 )} ( 4 i ) & {y}^{( 1 )} ( 4 i + 1 ) & {y}^{( 1 )} ( 4 i + 2 ) & {y}^{( 1 )} ( 4 i + 3 ) \\ {y}^{( 2 )} ( 4 i ) & {y}^{( 2 )} ( 4 i + 1 ) & {y}^{( 2 )} ( 4 i + 2 ) & {y}^{( 2 )} ( 4 i + 3 ) \\ {y}^{( 3 )} ( 4 i ) & {y}^{( 3 )} ( 4 i + 1 ) & {y}^{( 3 )} ( 4 i + 2 ) & {y}^{( 3 )} ( 4 i + 3 )\end{matrix} ] = {X}_{SFBC - FSTD} ( i ) ≡ \frac{1}{\sqrt{2}} [ \begin{matrix}{x}^{( 0 )} ( i ) & {x}^{( 1 )} ( i ) & 0 & 0 \\ 0 & 0 & {x}^{( 2 )} ( i ) & {x}^{( 3 )} ( i ) \\ - {( {x}^{( 1 )} ( i ) )}^{*} & {( {x}^{( 0 )} ( i ) )}^{*} & 0 & 0 \\ 0 & 0 & - {( {x}^{( 3 )} ( i ) )}^{*} & {( {x}^{( 2 )} ( i ) )}^{*}\end{matrix} ] . \qquad [ Eqn . 19 ]$$

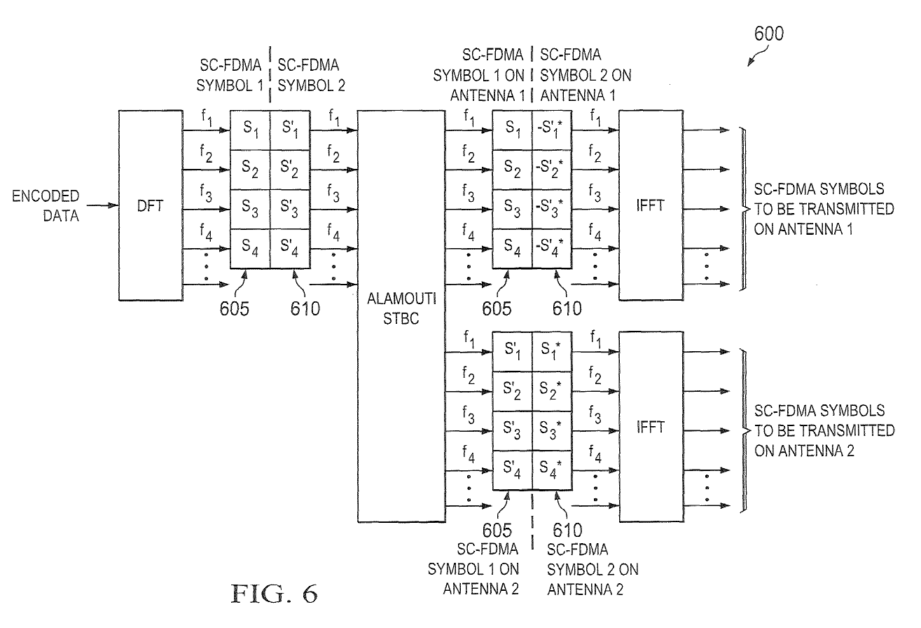

FIG. 6 illustrates details of an Alamouti STBC with SC-FDMA precoder 600 according to one embodiment of the present disclosure. The embodiment of the Alamouti STBC with SC-FDMA precoder 600 shown in FIG. 6 is for illustration only. Other embodiments of the Alamouti STBC with SC-FDMA precoder 600 could be used without departing from the scope of this disclosure.

In some embodiments, Transmit Diversity (TxD) is introduced into SC-FDMA systems using Alamouti preceding. Alamouti SFBC and STBC are considered for 2-TxD in SC-FDMA systems. For example, in embodiments utilizing Alamouti STBC, two adjacent SC-FDMA symbols 605, 610 are paired, as illustrated in FIG. 6.

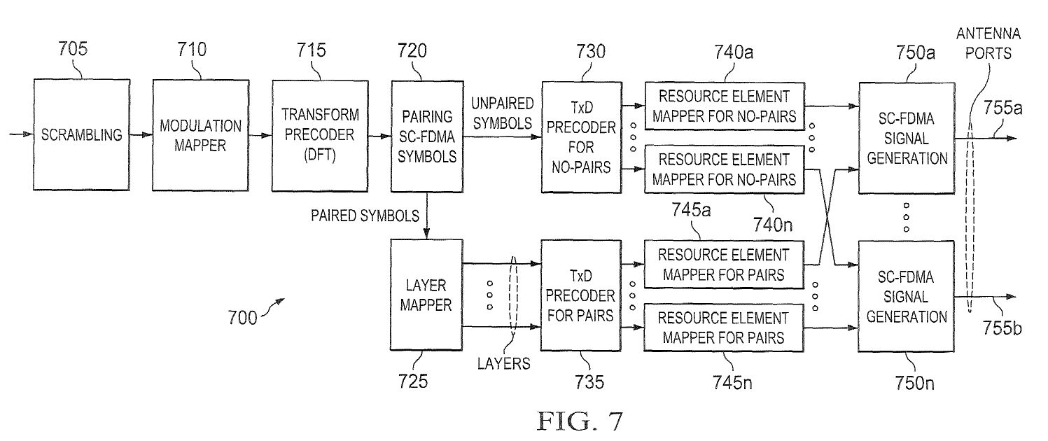

FIG. 7 illustrates a transmitter structure for 4-TxD schemes 700 according to one embodiment of the present disclosure. The embodiment of the transmitter structure for 4-TxD schemes 700 shown in FIG. 7 is for illustration only. Other embodiments of the transmitter structure for 4-TxD schemes 700 could be used without departing from the scope of this disclosure.

In some embodiments, transmitter structure for 4-TxD schemes 700 (hereinafter “transmitter” or “transmitter structure”) comprises a scrambling block 705 and a modulation mapper 710. Scrambling block 705 and modulation mapper 710 can be the same includes the same general structure and function as scrambling block 355 and a modulation mapper 360, discussed herein above with respect to FIG. 3B. The transmitter further includes a transform decoder 715, a SC-FDMA symbol pairing block 720 (hereinafter “pairing block”), a layer mapper 725, a TxD precoder for non-pairs 730 (hereinafter “non-pair precoder”), a TxD precoder for pairs 735 (hereinafter “paired precoder”), a plurality of resource element mappers for non-pairs 740 (hereinafter non-pair resource element mappers), a plurality of resource element mappers for pairs 745 (hereinafter pair resource element mappers), and a plurality of SC-FDMA signal generation blocks 750. The embodiment of the transmitter structure 700 illustrated in FIG. 7 is applicable to more than one physical channel. Although the illustrated embodiment shows two sets of components 740, 745 and 750 to generate two streams 755a-b for transmission by two antenna ports, it will be understood that transmitter 700 may comprise any suitable number of component sets 740, 745 and 750 based on any suitable number of streams 755 to be generated. Further illustration of the non-paired precoder 730 and the paired precoder 735 as separate elements merely is by way of example. It will be understood that the operations of non-paired precoder 730 and paired precoder 735 may be incorporated into a single component, or multiple components, without departing from the scope of this disclosure. At least some of the components in FIG. 7 may be implemented in software while other components may be implemented by configurable hardware or a mixture of software and configurable hardware.

An input to scrambling block 705 receives a block of bits. In some embodiments, the block of bits is encoded by a channel encoder. In some embodiments, the block of bits is not encoded by a channel encoder. The scrambling block 705 is operable to scramble the block of bits to be transmitted.

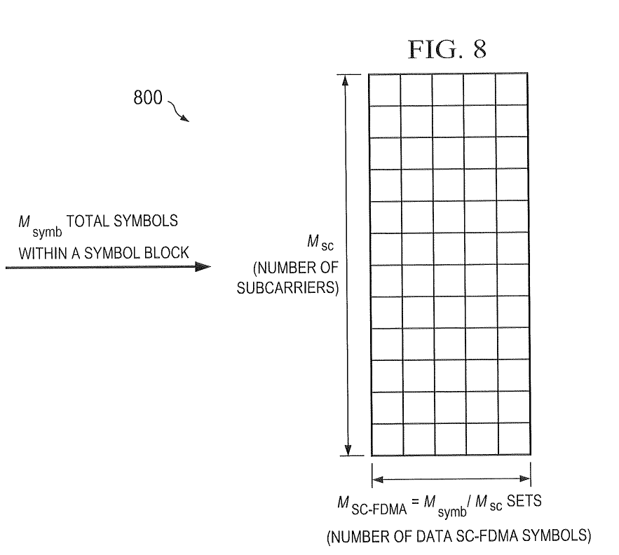

An input to the modulation mapper 710 receives the scrambled block of bits. The transmitter 700 is operable to perform modulation of the scrambled bits. The modulation mapper 710 modulates the block of scrambled bits. Modulation mapper 710 generates a block of symbols d(l·M_{sc}+i), where l=0, . . . ,M_{SC-FDMA}−1, i=0, . . . ,M_{sc}−1, M_{SC-FDMA} is the number of SC-FDMA symbols in a time slot devoted to data transmission and M_{sc} is the number of subcarriers that a UE (e.g., SS 116) is assigned for the transmission of the symbol block. M_{sc} is a multiple of four (4). The total number of symbols within the symbol block, M_{symb}, is the product of the number of SC-FDMA symbols and the number of subcarriers, or M_{sc}·M_{SC-FDMA}. The relation among these three numbers is illustrated in FIG. 8.

FIG. 8 illustrates a partition of a block of symbols 800 to be input to a DFT precoder 715 according to embodiments of the present disclosure. The embodiment of the partition of the block of symbols 800 is for illustration only. Other embodiments of the partition of the block of symbols 800 could be used without departing from the scope of this disclosure.

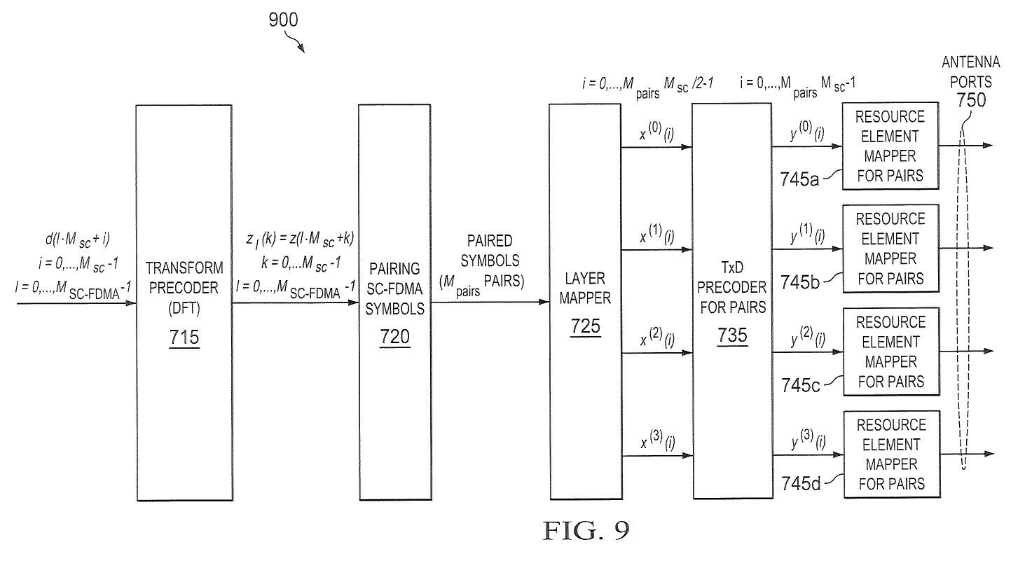

FIG. 9 illustrates a detailed view of the transmitter components for paired symbols 900 according to one embodiment of the present disclosure. The embodiment of the transmitter components for paired symbols 900 shown in FIG. 9 is for illustration only. Other embodiments of the transmitter components for paired symbols 900 could be used without departing from the scope of this disclosure.

An input to the transform precoder (hereinafter “DFT”) 715 is the output generated by the modulation mapper 710, which is d(l·M_{sc}+i). The DFT 715 divides the input symbols d(l·M_{sc}+i) into multiple sets, or M_{SC-FDMA}=M_{symb}/M_{sc} sets. Each set is composed of the number of subcarriers assigned for the UE's current transmission, or M_{sc}. Further, each set corresponds to one SC-FDMA symbol. Then, the DFT 715 transforms each set to the frequency domain by performing a DFT operation on each set using Equation 20:

$${z}_{l} ( k ) = z ( l \cdot {M}_{sc} + k ) = \frac{1}{\sqrt{{M}_{sc}}} {\sum }_{i = 0}^{{M}_{sc} - 1} d ( l \cdot {M}_{sc} + i ) {e}^{- j \frac{2 π i k}{{M}_{sc}}} . \qquad [ Eqn . 20 ]$$

In Equation 20, k=0, . . . ,M_{sc}−1 and l=0, . . . ,M_{symb}/M_{sc}−1.

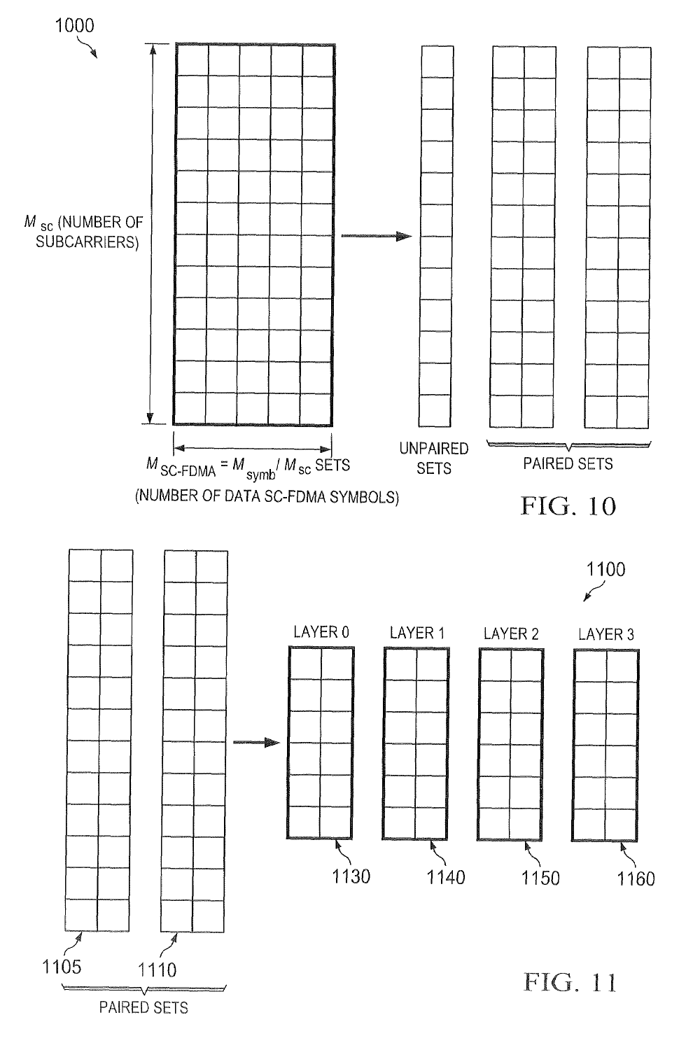

The transmitter 700 is configured to pair the SC-FDMA symbols in the pairing block 720. The pairing block 720 receives the output from the DFT 715. The pairing operation is further illustrated in FIG. 10.

FIG. 10 illustrates a pairing operation 1000 according to embodiments of the present disclosure. The embodiment of the pairing operation 1000 shown in FIG. 10 is for illustration only. Other embodiments of the pairing operation 1000 could be used without departing from the scope of this disclosure.

The pairing block 720 pairs a subset of the input sets zₗ(k), l=0, . . . ,M_{SC-FDMA}−1, k=0, . . . ,M_{sc}−1 and leaves the complement of the subset to remain unpaired. The number of pairs constructed by the pairing block 720 is denoted by Mₚₐᵢᵣₛ. Further, pair n is composed of two input sets, pₙ⁽⁰⁾(k) and pₙ⁽¹⁾(k), where n=0, . . . ,Mₚₐᵢᵣₛ−1 and k=0, . . . ,M_{sc}−1. The number of unpaired sets is denoted by Mₙₒ₋ₚₐᵢᵣₛ. Further, unpaired sets are denoted by p′ₙ(k), n=0, . . . ,Mₙₒ₋ₚₐᵢᵣₛ−1. Thus, the number of symbols M_{symb} has a relation with Mₚₐᵢᵣₛ, Mₙₒ₋ₚₐᵢᵣₛ and M_{sc} as illustrated in Equation 21:

M_{symb}=M_{sc}(Mₙₒ₋ₚₐᵢᵣₛ+2Mₚₐᵢᵣₛ). [Eqn. 21]

In some embodiments, the number of data SC-FDMA symbols is even. In such embodiments, the pairing block 720 pairs two adjacent sets such that all the sets are paired. For example, pₙ⁽⁰⁾(k)=z₂ₙ(k) and pₙ⁽¹⁾(k)=z₂ₙ₊₁(k), for n=0, . . . ,M_{SC-FDMA}/2−1, k=0, . . . ,M_{sc}−1. Then, the number of pairs is Mₚₐᵢᵣₛ=M_{SC-FDMA}/2, and the number of no-pairs is Mₙₒ₋ₚₐᵢᵣₛ=0.

In some embodiments, the number of data SC-FDMA symbols is odd. In one such embodiment, the pairing block 720 does not pair the right-most set (e.g., the right-most set is unpaired). For example, pₙ⁽⁰⁾(k)=z₂ₙ(k) and pₙ⁽¹⁾(k)=z₂ₙ₊₁(k), for n=0, . . . ,(M_{SC-FDMA}−1)/2−1; in addition, p′₀(k)=z_{SC-FDMA-1}(k). Then, the number of pairs is Mₚₐᵢᵣₛ=(M_{SC-FDMA}−1)/2 and the number of no-pairs is Mₙₒ₋ₚₐᵢᵣₛ=1.

In an additional and alternative embodiment where the number of data SC-FDMA symbols is odd, the pairing block 720 does not pair the left-most set (e.g., the left-most set is unpaired). For example, p′₀(k)=z₀(k); in addition, pₙ⁽⁰⁾(k)=z₂ₙ₊₁(k) and pₙ⁽¹⁾(k)=z₂ₙ₊₂(k), for n=0, . . . ,(M_{SC-FDMA}−1)/2−1. Then, the number of pairs is Mₚₐᵢᵣₛ=(M_{SC-FDMA}−1)/2 and the number of no-pairs is Mₙₒ₋ₚₐᵢᵣₛ=1.

After the pairing operation, the transmitter 700 is operable to perform layer mapping on the paired sets using the layer mapper 725. The layer mapper 725 receives the paired sets from the pairing block 720. The layer mapping operation is further illustrated in FIG. 11.

FIG. 11 illustrates a layer mapping operation 1100 according to embodiments of the present disclosure. The embodiment of the layer mapping operation 1100 shown in FIG. 11 is for illustration only. Other embodiments of the layer mapping operation 1100 could be used without departing from the scope of this disclosure.

The layer mapper 725 partitions the paired sets 1105, 1110 into four groups of the equal size of M_{sc}/2. The layer mapper 725 partitions all the pairs in an identical way. The layer mapper 725 then maps the symbols in each group into each layer output, x⁽⁰⁾(i) 1130, x⁽¹⁾(i) 1140, x⁽²⁾(i) 1150 and x⁽³⁾(i) 1160, for i=0, . . . ,MₚₐᵢᵣₛM_{sc}/2−1.

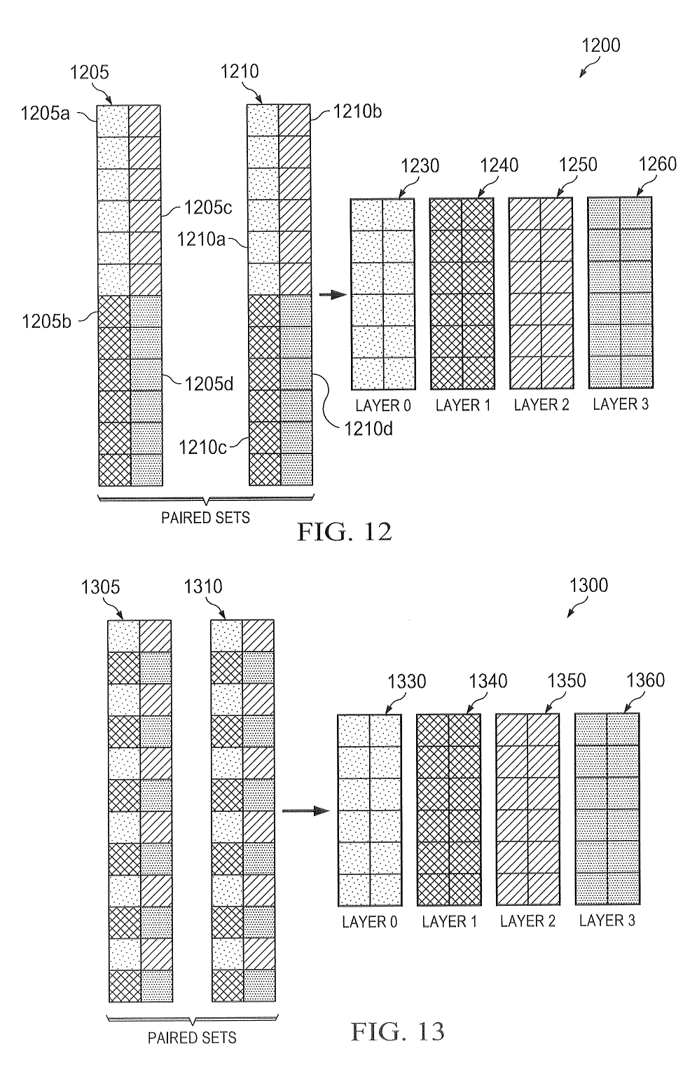

FIG. 12 illustrates a top-down split layer mapping method 1200 according to embodiments of the present disclosure. The embodiment of the top-down split layer mapping method 1200 shown in FIG. 12 is for illustration only. Other embodiments of the top-down split layer mapping method 1200 could be used without departing from the scope of this disclosure.

In some embodiments, the layer mapper 725 utilizes a top-down split method to map the paired sets 1205, 1210. The layer mapper 725 maps a left side of each paired set 1205, 1210 to layer “0” 1230 and layer “1” 1240 and a right side side of each paired set 1205, 1210 to layer “2” 1250 and layer “3” 1260. For example, the layer mapper 725 maps a top half 1205a of the left side of paired set 1205 to layer “0” 1230. Further, the layer mapper 725 maps a top half 1210a of the left side of paired set 1210 to layer “0” 1230. The layer mapper 725 maps a bottom half 1205b of the left side of paired set 1205 to layer “1” 1240. Further, the layer mapper 725 maps a bottom half 1210b of the left side of paired set 1210 to layer “1” 1240. The layer mapper 725 maps a right side of each paired set 1205, 1210 to layer “2” 1250 and layer “3” 1260. The layer mapper 725 maps a top half 1205c of the right side of paired set 1205 to layer “2” 1250. Further, the layer mapper 725 maps a top half 1210c of the right side of paired set 1210 to layer “2” 1250. The layer mapper 725 maps a bottom half 1205b of the right side of paired set 1205 to layer “2” 1250. Further, the layer mapper 725 maps a bottom half 1210d of the left side of paired set 1210 to layer “3” 1260.

The layer mapper 725 maps elements pₙ⁽⁰⁾(k), k=0, . . . ,M_{sc}/2−1, n=0, . . . ,Mₚₐᵢᵣₛ−1 to layer “0” 1230. The layer mapper 725 maps elements pₙ⁽⁰⁾(k) , k=M_{sc}/2, . . . ,M_{sc}−1, n=0, . . . ,Mₚₐᵢᵣₛ−1 to layer “1” 1240. The layer mapper 725 maps elements pₙ⁽¹⁾(k), k=0, . . . ,M_{sc}/2−1, n=0, . . . ,Mₚₐᵢᵣₛ−1 to layer “2” 1250. Then, the layer mapper 725 maps elements pₙ⁽⁰⁾(k), k=M_{sc}/2, . . . ,M_{sc}−1, n=0, . . . ,Mₚₐᵢᵣₛ−1 to layer “3” 1260. Furthermore, in each layer, the mapping is in increasing order of the subcarrier index k, and then pair index n as defined by Equations 22 and 23:

x⁽⁰⁾(nM_{sc}/2+k)=pₙ⁽⁰⁾(k), x⁽¹⁾(nM_{sc}/2+k)=pₙ⁽⁰⁾(k+M_{sc}/2). [Eqn. 22]

x⁽²⁾(nM_{sc}/2+k)=pₙ⁽¹⁾(k) and x⁽³⁾(nM_{sc}/2+k)=pₙ⁽¹⁾(k+M_{sc}/2). [Eqn. 23]

In Equations 22 and 23, k=0, . . . ,M_{sc}/2−1, n=0, . . . ,Mₚₐᵢᵣₛ−1.

FIG. 13 illustrates an even-odd split layer mapping method 1300 according to embodiments of the present disclosure. The embodiment of the even-odd split layer mapping method 1300 shown in FIG. 13 is for illustration only. Other embodiments of the even-odd split layer mapping method 1300 could be used without departing from the scope of this disclosure.

In some embodiments, the layer mapper 725 utilizes an even-odd split method to map the paired sets 1205, 1210. The layer mapper 725 maps the even positions in the left side of each pair 1305, 1310 (e.g., even-th element from the bottom of the paired set 1205, 1210) to layer “0” 1330. The layer mapper 725 maps the odd positions in the left side of each pair 1305, 1310 (e.g., odd-th element from the bottom of the paired set 1205, 1210) to layer “1” 1340. For example, the layer mapper 725 maps elements pₙ⁽⁰⁾(k), k=0,2, . . . ,M_{sc}−2, n=0, . . . ,Mₚₐᵢᵣₛ−1 to layer “0” 1330. The layer mapper 725 maps elements pₙ⁽⁰⁾(k), k=1,3, . . . ,M_{sc}−1, n=0, . . . ,Mₚₐᵢᵣₛ−1 to layer “1” 1340. The layer mapper 725 maps elements pₙ⁽¹⁾(k), k=0,2, . . . ,M_{sc}−2, n=0, . . . ,Mₚₐᵢᵣₛ−1 to layer “2” 1350. Then, the layer mapper 725 maps elements pₙ⁽⁰⁾(k), k=1,3, . . . ,M_{sc}−1, n=0, . . . ,Mₚₐᵢᵣₛ−1 to layer “3” 1360. Furthermore, in each layer, the mapping is in increasing order of the subcarrier index k, and then pair index n as defined by Equations 24, 25 and 26:

x⁽⁰⁾(nM_{sc}/2+k)=pₙ⁽⁰⁾(2k), x⁽¹⁾(nM_{sc}/2+k)=pₙ⁽⁰⁾(2k+1). [Eqn. 24]

x⁽²⁾(nM_{sc}/2+k)=pₙ⁽¹⁾(2k). [Eqn. 25]

x⁽³⁾(nM_{sc}/2+k)=pₙ⁽¹⁾(2k+1). [Eqn. 26]

In Equations 24, 25 and 26, k=0, . . . ,M_{sc}/2−1, n=0, . . . ,Mₚₐᵢᵣₛ−1.

The output of the layer mapper 725 is coupled to the input of the paired precoder 735. The paired precoder 735 receives the layer mapper 725 output, e.g., x⁽⁰⁾(i), x⁽¹⁾(i), x⁽²⁾(i) and x⁽³⁾(i), for i=0, . . . ,MₚₐᵢᵣₛM_{sc}/2−1. The paired precoder 735 generates a combination of the inputs to generate precoded outputs according to 4-Tx Alamouti STBC-FSTD preceding. The precoded outputs are denoted by y⁽⁰⁾(i), y⁽¹⁾(i), y⁽²⁾(i) and y⁽³⁾(i). Each of the precoded outputs will be mapped to antenna ports “0”, “1”, “2” and “3”. The length of each output is twice the number of pairs times the number of subcarriers, or, i=0, . . . ,2M_{sc}Mₚₐᵢᵣₛ−1.

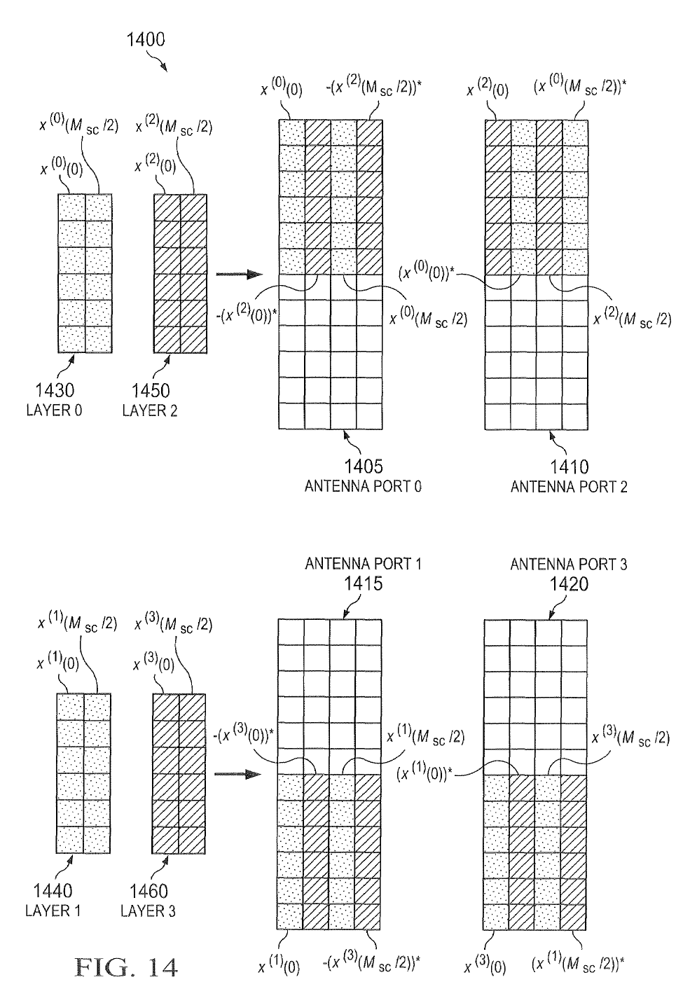

FIG. 14 illustrates a top-down split TxD preceding method 1400 according to embodiments of the present disclosure. The embodiment of the top-down split TxD precoding method 1400 shown in FIG. 14 is for illustration only. Other embodiments of the top-down split TxD preceding method 1400 could be used without departing from the scope of this disclosure.

In some embodiments, the paired precoder 735 utilizes a top-down split TxD precoding method 1400 to precode the layered elements (e.g., outputs from layer mapper 725). For the top half subcarriers of antenna ports “0” 1405 and “2” 1410, the paired precoder 735 precodes the elements of layer “0” 1430 and layer “2” 1450 according to Alamouti STBC, while the bottom half subcarriers of antenna ports “0” 1405 and “2” 1410 are set to zero (0). Further, for the bottom half subcarriers of antenna ports “1” 1415 and “3” 1420, the paired precoder 735 precodes the elements of layer “1” 1440 and layer “3” 1460 according to Alamouti STBC, while the top half subcarriers of antenna ports “1” 1415 and “3” 1420 are set to zero (0). For example, the outputs of the paired precoder 735 are defined by Equations 27, 28, 29 and 30:

$$\begin{matrix}{y}^{( 0 )} ( {nM}_{sc} + k ) = \{ \begin{matrix}{x}^{( 0 )} ( {nM}_{sc} / 4 + k ) , & k = 0 , … , {M}_{sc} / 2 - 1 , n even , \\ - {( {x}^{( 2 )} ( ( n - 1 ) {M}_{sc} / 4 + k ) )}^{*} & k = 0 , … , {M}_{sc} / 2 - 1 , n odd , \\ 0 & k = {M}_{sc} / 2 , … , {M}_{sc} - 1 , ∀ n , .\end{matrix} & [ Eqn . 27 ] \\ {y}^{( 1 )} ( {nM}_{sc} + k ) = \{ \begin{matrix}{x}^{( 1 )} ( {nM}_{sc} / 4 + k - {M}_{sc} / 2 ) , & k = {M}_{sc} / 2 , … , {M}_{sc} - 1 , n even , \\ - {( {x}^{( 3 )} ( \begin{matrix}( n - 1 ) {M}_{sc} / 4 + \\ k - {M}_{sc} / 2\end{matrix} ) )}^{*} & k = {M}_{sc} / 2 , … , {M}_{sc} - 1 , n odd , \\ 0 & k = 0 , … , {M}_{sc} / 2 - 1 , ∀ n , .\end{matrix} & [ Eqn . 28 ] \\ {y}^{( 2 )} ( {nM}_{sc} + k ) = \{ \begin{matrix}{x}^{( 2 )} ( {nM}_{sc} / 4 + k ) , & k = 0 , … , {M}_{sc} / 2 - 1 , n even , \\ {( {x}^{( 0 )} ( ( n - 1 ) {M}_{sc} / 4 + k ) )}^{*} & k = 0 , … , {M}_{sc} / 2 - 1 , n odd , \\ 0 & k = {M}_{sc} / 2 , … , {M}_{sc} - 1 , ∀ n , .\end{matrix} & [ Eqn . 29 ] \\ {y}^{( 3 )} ( {nM}_{sc} + k ) = \{ \begin{matrix}{x}^{( 3 )} ( {nM}_{sc} / 4 + k - {M}_{sc} / 2 ) , & k = {M}_{sc} / 2 , … , {M}_{sc} - 1 , n even , \\ {( {x}^{( 1 )} ( \begin{matrix}( n - 1 ) {M}_{sc} / 4 + \\ k - {M}_{sc} / 2\end{matrix} ) )}^{*} & k = {M}_{sc} / 2 , … , {M}_{sc} - 1 , n odd , \\ 0 & k = 0 , … , {M}_{sc} / 2 - 1 , ∀ n , .\end{matrix} & [ Eqn . 30 ]\end{matrix}$$

In Equations 27-30, n=0, . . . ,2Mₚₐᵢᵣₛ−1.

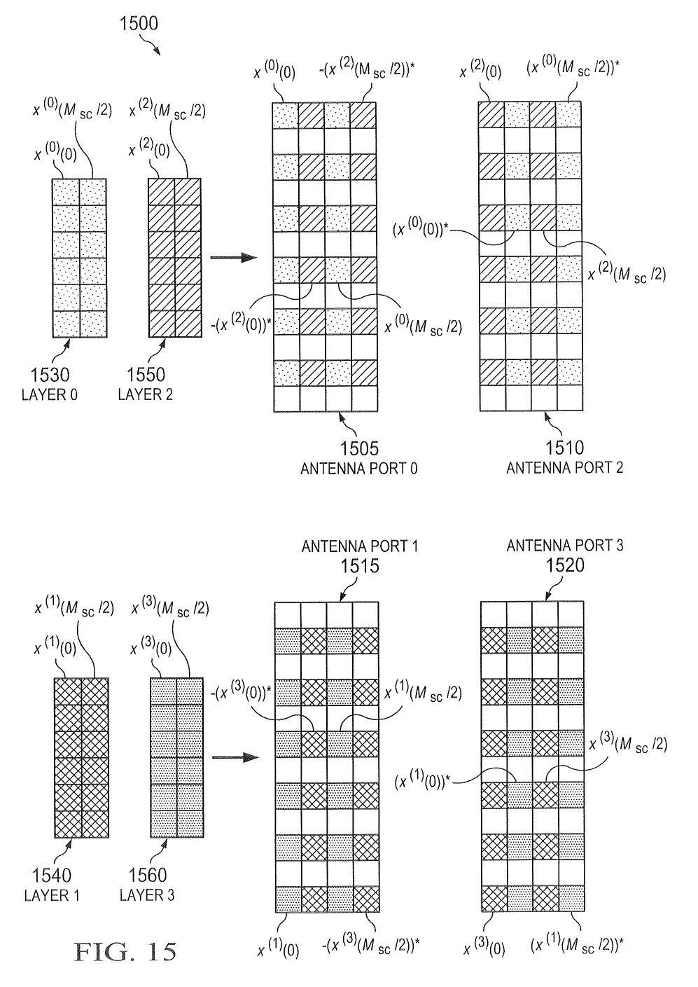

FIG. 15 illustrates an even-odd split TxD preceding method 1500 according to embodiments of the present disclosure. The embodiment of the even-odd split TxD preceding method 1500 shown in FIG. 15 is for illustration only. Other embodiments of the even-odd split TxD preceding method 1500 could be used without departing from the scope of this disclosure.

In some embodiments, the paired precoder 735 utilizes an even-odd split TxD precoding method 1500 to precode the layered elements (e.g., outputs from layer mapper 725). For the even-th subcarriers of antenna ports “0” 1505 and “2” 1510, the paired precoder 735 precodes the elements of layer “0” 1530 and layer “2” 1550 according to Alamouti STBC, while the odd-th subcarriers of antenna ports “0” 1505 and “2” 1510 are all set to zero (0). Additionally, for the even-th subcarriers of antenna ports “1” 1515 and “3” 1520, the paired precoder 735 precodes the elements of layer “1” 1540 and layer “3” 1560 according to Alamouti STBC, while the odd-th subcarriers of antenna ports “1” 1515 and “3” 1520 are set to zero (0). For example, the outputs of the paired precoder 735 are defined by Equations 31, 32, 33 and 34:

$$\begin{matrix}{y}^{( 0 )} ( {nM}_{sc} + k ) = \{ \begin{matrix}{x}^{( 0 )} ( {nM}_{sc} / 4 + k / 2 ) , & k even , n even , \\ - {( {x}^{( 2 )} ( ( n - 1 ) {M}_{sc} / 4 + k / 2 ) )}^{*} & k even , n even , \\ 0 & k odd , ∀ n , .\end{matrix} & [ Eqn . 31 ] \\ {y}^{( 1 )} ( {nM}_{sc} + k ) = \{ \begin{matrix}{x}^{( 1 )} ( {nM}_{sc} / 4 + ( k - 1 ) / 2 ) , & k odd , n even , \\ - {( {x}^{( 3 )} ( ( n - 1 ) {M}_{sc} / 4 + ( k - 1 ) / 2 ) )}^{*} & k odd , n odd , \\ 0 & k odd , ∀ n , .\end{matrix} & [ Eqn . 32 ] \\ {y}^{( 2 )} ( {nM}_{sc} + k ) = \{ \begin{matrix}{x}^{( 2 )} ( {nM}_{sc} / 4 + k / 2 ) , & k even , n even , \\ {( {x}^{( 0 )} ( ( n - 1 ) {M}_{sc} / 4 + k / 2 ) )}^{*} & k even , n odd , \\ 0 & k odd , ∀ n , .\end{matrix} & [ Eqn . 33 ] \\ {y}^{( 3 )} ( {nM}_{sc} + k ) = \{ \begin{matrix}{x}^{( 3 )} ( {nM}_{sc} / 4 + ( k - 1 ) / 2 ) , & k odd , n even , \\ {( {x}^{( 1 )} ( ( n - 1 ) {M}_{sc} / 4 + ( k - 1 ) / 2 ) )}^{*} & k odd , n odd , \\ 0 & k even , ∀ n , .\end{matrix} & [ Eqn . 34 ]\end{matrix}$$

In Equations 31-34, n=0, . . . ,2Mₚₐᵢᵣₛ−1 and k=0, . . . ,M_{sc}−1.

The non-paired precoder 730 is coupled to the output of the pairing block 720. As stated herein above with respect to FIGS. 7 and 9, the pairing block 720 pairs the subset of the input and, in some embodiments, leaves the complement of the subset to remain unpaired. Accordingly, in some embodiments, an unpaired set is sent to the non-paired precoder 730. In such embodiments, the input of the non-paired precoder 730 receives the no-paired outputs of the pairing block 720, e.g., receives p′ₙ(k), n=0, . . . ,Mₙₒ₋ₚₐᵢᵣₛ−1. The non-paired precoder 730 generates a combination of the inputs to generate precoded outputs for the no-pairs. The precoded outputs are denoted by y′⁽⁰⁾(i), y′⁽¹⁾(i), y′⁽²⁾(i) and y′⁽³⁾(i), where the length of each output is the number of no-pairs times the number of subcarriers, or, i=0, . . . ,Mₙₒ₋ₚₐᵢᵣₛM_{sc}−1.

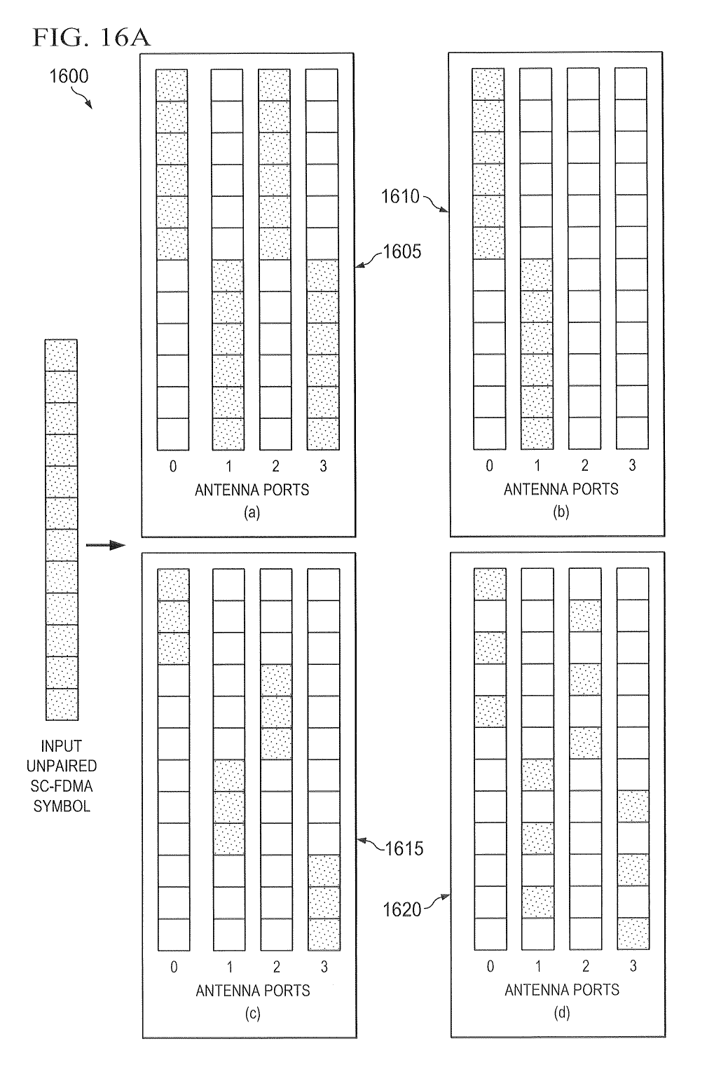

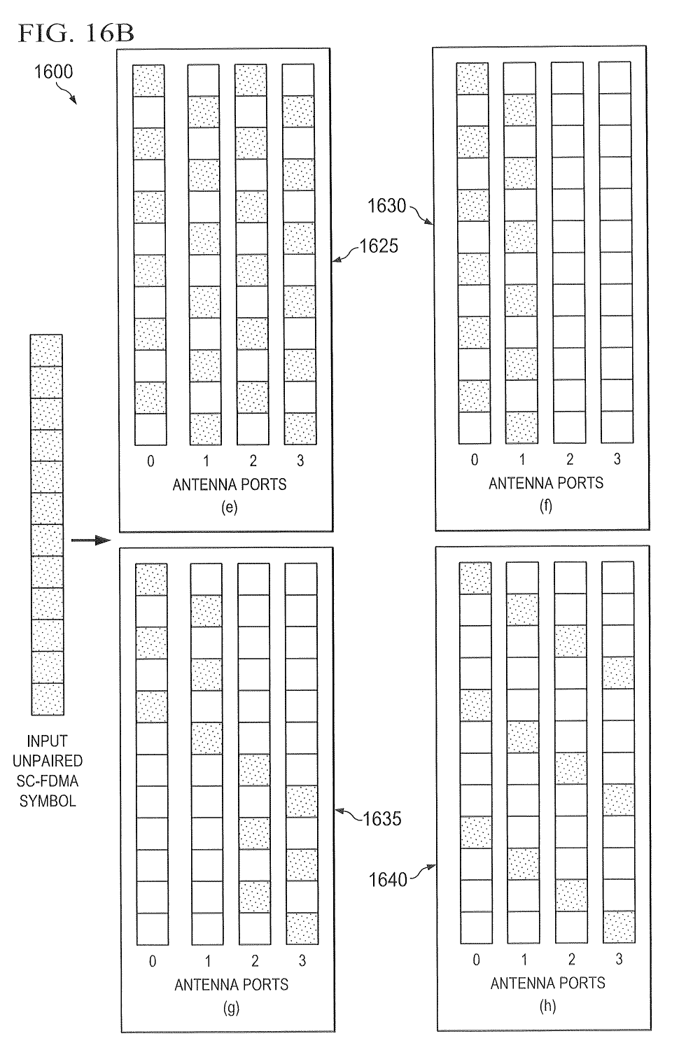

FIGS. 16A and 16B illustrate no-paired TxD precoding methods 1600 according to embodiments of the present disclosure. The embodiment of the no-paired TxD precoding methods 1600 shown in FIGS. 16A and 16B is for illustration only. Other embodiments of the no-paired TxD preceding methods 1600 could be used without departing from the scope of this disclosure.

In one embodiment, illustrated in FIG. 16A-(a), the non-paired precoder 730 utilizes a top-down split with repetition TxD preceding method 1605 to precode the no-paired sets (e.g., unpaired symbols output from pairing block 720). The non-paired precoder 730 maps the first half of the input, i.e., p′ₙ(k), k=0, . . . ,M_{sc}/2−1 for each n=0, . . . ,Mₙₒ₋ₚₐᵢᵣₛ−1, onto the top half subcarriers of the two precoder outputs. Additionally, the non-paired precoder 730 maps the last half of the input, i.e., p′ₙ(k), k=M_{sc}/2, . . . ,M_{sc}−1, for each n=0, . . . ,Mₙₒ₋ₚₐᵢᵣₛ−1, onto the bottom half subcarriers of the other two precoder outputs. The mapping is performed in the increasing order of subcarrier index k, then n. The subcarriers at each precoder output, onto which the input signal is not mapped, are filled with zeros. For example, the TxD preceding outputs are defined by Equations 35 and 36:

$$\begin{matrix}\begin{matrix}{y}^{′ ( 0 )} ( {nM}_{sc} + k ) = {y}^{′ ( 2 )} ( {nM}_{sc} + k ) \\ = \{ \begin{matrix}{p}_{n}^{′} ( k ) , & k = 0 , … , {M}_{sc} / 2 - 1 \\ 0 , & k = {M}_{sc} / 2 , … {M}_{sc} - 1.\end{matrix}\end{matrix} & [ Eqn . 35 ] \\ \begin{matrix}{y}^{′ ( 1 )} ( {nM}_{sc} + k ) = {y}^{′ ( 3 )} ( {nM}_{sc} + k ) \\ = \{ \begin{matrix}0 , & k = 0 , … , {M}_{sc} / 2 - 1 \\ {p}_{n}^{′} ( k ) , & k = {M}_{sc} / 2 , … {M}_{sc} - 1.\end{matrix}\end{matrix} & [ Eqn . 36 ]\end{matrix}$$

In Equations 35 and 36, n=0, . . . ,Mₙₒ₋ₚₐᵢᵣₛ−1.

In another embodiment, illustrated in FIG. 16A-(b), the non-paired precoder 730 utilizes a top-down split with single-antenna transmission TxD preceding method 1610 to precode the no-paired sets (e.g., unpaired symbols output from pairing block 720). The non-paired precoder 730 maps the first half of the input, i.e., p′ₙ(k), k=0, . . . ,M_{sc}/2−1 for each n=0, . . . ,Mₙₒ₋ₚₐᵢᵣₛ−1, to the top half subcarriers of one precoder outputs. Additionally, the non-paired precoder 730 maps the last half of the input, i.e., p′ₙ(k), k=M_{sc}/2, . . . ,M_{sc}−1, for each n=0, . . . ,Mₙₒ₋ₚₐᵢᵣₛ−1, to the bottom half subcarriers of another precoder output. The mapping is performed in the increasing order of subcarrier index k, then n. For the other precoder outputs, zero signals are mapped. The subcarriers at each precoder output, onto which the input signal is not mapped, are filled with zeros. For example, the TxD preceding outputs are defined by Equations 37, 38, 39 and 40:

$$\begin{matrix}{y}^{′ ( 0 )} ( {nM}_{sc} + k ) = \{ \begin{matrix}{p}_{n}^{′} ( k ) , & k = 0 , … , {M}_{sc} / 2 - 1 \\ 0 , & k = {M}_{sc} / 2 , … {M}_{sc} - 1.\end{matrix} & [ Eqn . 37 ] \\ {y}^{′ ( 2 )} ( {nM}_{sc} + k ) = 0 , k = 0 , … , {M}_{sc} - 1. & [ Eqn . 38 ] \\ {y}^{′ ( 1 )} ( {nM}_{sc} + k ) = \{ \begin{matrix}0 , & k = 0 , … , {M}_{sc} / 2 - 1 \\ {p}_{n}^{′} ( k ) , & k = {M}_{sc} / 2 , … {M}_{sc} - 1.\end{matrix} & [ Eqn . 39 ] \\ {y}^{′ ( 3 )} ( {nM}_{sc} + k ) = 0 , k = 0 , … , {M}_{sc} - 1 & [ Eqn . 40 ]\end{matrix}$$

In Equations 37-40, n=0, . . . ,Mₙₒ₋ₚₐᵢᵣₛ−1.

In another embodiment, illustrated in FIG. 16A-(c), the non-paired precoder 730 utilizes a no-pairs C TxD preceding method 1615 to precode the no-paired sets (e.g., unpaired symbols output from pairing block 720). The non-paired precoder 730 maps each quarter of the input p′ₙ(k), k=0, . . . ,M_{sc}−1 for each n=0, . . . ,Mₙₒ₋ₚₐᵢᵣₛ−1, to the corresponding quarter subcarriers of a precoder output in the increasing order of subcarrier index k, then n. The subcarriers at each precoder output, onto which the input signal is not mapped, are filled with zeros. For example, the TxD preceding outputs are defined by Equations 41, 42, 43 and 44:

$$\begin{matrix}{y}^{′ ( 0 )} ( {nM}_{sc} + k ) = \{ \begin{matrix}{p}_{n}^{′} ( k ) , & k = 0 , … , {M}_{sc} / 4 - 1 \\ 0 , & k = {M}_{sc} / 4 , … , {M}_{sc} - 1.\end{matrix} & [ Eqn . 41 ] \\ {y}^{′ ( 1 )} ( {nM}_{sc} + k ) = \{ \begin{matrix}{p}_{n}^{′} ( k ) , & k = {M}_{sc} / 2 , … , 3 {M}_{sc} / 4 - 1 \\ 0 , & \begin{matrix}k = 0 , … , {M}_{sc} / 2 - 1 , \\ or k = 3 {M}_{sc} / 4 , … , {M}_{sc} - 1.\end{matrix}\end{matrix} & [ Eqn . 42 ] \\ {y}^{′ ( 2 )} ( {nM}_{sc} + k ) = \{ \begin{matrix}{p}_{n}^{′} ( k ) , & k = {M}_{sc} / 4 , … , {M}_{sc} / 2 - 1 \\ 0 , & \begin{matrix}k = 0 , … , {M}_{sc} / 4 - 1 , \\ or k = {M}_{sc} / 2 , … , {M}_{sc} - 1.\end{matrix}\end{matrix} & [ Eqn . 43 ] \\ {y}^{′ ( 3 )} ( {nM}_{sc} + k ) = \{ \begin{matrix}{p}_{n}^{′} ( k ) , & k = 3 {M}_{sc} / 4 , … , {M}_{sc} - 1 \\ 0 , & k = 0 , … , 3 {M}_{sc} / 4 - 1 \end{matrix} & [ Eqn . 44 ]\end{matrix}$$

In Equations 41-44, n=0, . . . ,Mₙₒ₋ₚₐᵢᵣₛ−1.

In another embodiment illustrated in FIG. 16A-(d), the non-paired precoder 730 utilizes a no-pairs D TxD preceding method 1620 (and 1635) to precode the no-paired sets (e.g., unpaired symbols output from pairing block 720). The non-paired precoder 730 maps the elements at the even-th position of the first half of the input signal, i.e., p′ₙ(k), k=2,4, . . . ,M_{sc}/2−2, for each n=0, . . . ,Mₙₒ₋ₚₐᵢᵣₛ−1 to the corresponding subcarriers of a precoder output. Further, the non-paired precoder 730 maps the elements at the odd-th position of the first half of the input signal, i.e., p′ₙ(k), k=1,3, . . . ,M_{sc}/2−1, for each n=0, . . . ,Mₙₒ₋ₚₐᵢᵣₛ−1 to the corresponding subcarriers of another precoder output. The even-th and the odd-th elements of the last half for each n=0, . . . ,Mₙₒ₋ₚₐᵢᵣₛ−1 are separately mapped to the corresponding subcarriers of the other precoder outputs. The subcarriers at each precoder output, onto which the input signal is not mapped, are filled with zeros. For example, the TxD precoding outputs are defined by Equations 45, 46, 47 and 48:

$$\begin{matrix}{y}^{′ ( 0 )} ( {nM}_{sc} + k ) = \{ \begin{matrix}{p}_{n}^{′} ( k ) , & for k = 0 , 2 , … , {M}_{sc} / 2 - 2 \\ 0 , & otherwise .\end{matrix} & [ Eqn . 45 ] \\ {y}^{′ ( 1 )} ( {nM}_{sc} + k ) = \{ \begin{matrix}{p}_{n}^{′} ( k ) , & \begin{matrix}for k = {M}_{sc} / 2 , {M}_{sc} / \\ 2 + 2 , … , {M}_{sc} / 2 ,\end{matrix} \\ 0 , & otherwise\end{matrix} & [ Eqn . 46 ] \\ {y}^{′ ( 2 )} ( {nM}_{sc} + k ) = \{ \begin{matrix}{p}_{n}^{′} ( k ) , & for k = 1 , 3 , … , {M}_{sc} / 2 - 1 \\ 0 , & otherwise .\end{matrix} & [ Eqn . 47 ] \\ {y}^{′ ( 3 )} ( {nM}_{sc} + k ) = \{ \begin{matrix}{p}_{n}^{′} ( k ) , & \begin{matrix}for k = {M}_{sc} / 2 + 1 , {M}_{sc} / \\ 2 + 3 , … {M}_{sc} - 1 ,\end{matrix} \\ 0 , & otherwise\end{matrix} & [ Eqn . 48 ]\end{matrix}$$

In Equations 45-48, n=0, . . . ,Mₙₒ₋ₚₐᵢᵣₛ−1.

In another example, illustrated in FIG. 16B-(g), the outputs of the TxD precoders are defined by Equations 49, 50, 51 and 52:

$$\begin{matrix}{y}^{′ ( 0 )} ( {nM}_{sc} + k ) = \{ \begin{matrix}{p}_{n}^{′} ( k ) , & for k = 0 , 2 , … , {M}_{sc} / 2 - 2 \\ 0 , & otherwise .\end{matrix} & [ Eqn . 49 ] \\ {y}^{′ ( 1 )} ( {nM}_{sc} + k ) = \{ \begin{matrix}{p}_{n}^{′} ( k ) , & for k = 1 , 3 , … , {M}_{sc} / 2 - 1 \\ 0 , & otherwise .\end{matrix} & [ Eqn . 50 ] \\ {y}^{′ ( 2 )} ( {nM}_{sc} + k ) = \{ \begin{matrix}{p}_{n}^{′} ( k ) , & \begin{matrix}for k = {M}_{sc} / 2 , {M}_{sc} / \\ 2 + 2 , … {M}_{sc} - 2 ,\end{matrix} \\ 0 , & otherwise\end{matrix} & [ Eqn . 51 ] \\ {y}^{′ ( 3 )} ( {nM}_{sc} + k ) = \{ \begin{matrix}{p}_{n}^{′} ( k ) , & \begin{matrix}for k = {M}_{sc} / 2 + 1 , {M}_{sc} / \\ 2 + 3 , … {M}_{sc} - 1 ,\end{matrix} \\ 0 , & otherwise\end{matrix} & [ Eqn . 52 ]\end{matrix}$$

In Equations 49-52, n=0, . . . ,Mₙₒ₋ₚₐᵢᵣₛ−1.

In another embodiment, illustrated in FIG. 16B-(e), the non-paired precoder 730 utilizes a no-pairs E with even-odd split with repetition TxD preceding method 1625 to precode the no-paired sets (e.g., unpaired symbols output from pairing block 720). The non-paired precoder 730 maps the elements at the even-th position of the input signal, i.e., p′ₙ(k), k=2,4, . . . ,M_{sc}−2, for each n=0, . . . ,Mₙₒ₋ₚₐᵢᵣₛ−1, to the corresponding subcarriers of two precoder outputs. Additionally, the non-paired precoder 730 maps the elements at the odd-th position of the first half of the input signal, i.e., p′ₙ(k), k=1,3, . . . ,M_{sc}−1, for each n=0, . . . ,Mₙₒ₋ₚₐᵢᵣₛ−1, to the corresponding subcarriers of the other two precoder outputs. The subcarriers at each precoder output, onto which the input signal is not mapped, are filled with zeros. For example, the TxD precoding outputs are defined by Equations 53 and 54:

$$\begin{matrix}\begin{matrix}{y}^{′ ( 0 )} ( {nM}_{sc} + k ) = {y}^{′ ( 2 )} ( {nM}_{sc} + k ) \\ = \{ \begin{matrix}{p}_{n}^{′} ( k ) , & for k = 0 , 2 , … , {M}_{sc} - 2 \\ 0 , & otherwise .\end{matrix}\end{matrix} & [ Eqn . 53 ] \\ \begin{matrix}{y}^{′ ( 1 )} ( {nM}_{sc} + k ) = {y}^{′ ( 3 )} ( {nM}_{sc} + k ) \\ = \{ \begin{matrix}{p}_{n}^{′} ( k ) , & for k = 1 , 3 , … , {M}_{sc} - 1 , \\ 0 , & otherwise\end{matrix}\end{matrix} & [ Eqn . 54 ]\end{matrix}$$

In Equations 53 and 54, n=0, . . . ,Mₙₒ₋ₚₐᵢᵣₛ−1.

In another embodiment, illustrated in FIG. 16B-(f), the non-paired precoder 730 utilizes a no-pairs F with even-odd split with single antenna transmission TxD preceding method 1630 to precode the no-paired sets (e.g., unpaired symbols output from pairing block 720). The non-paired precoder 730 maps the elements at the even-th position of the input signal, i.e., p′ₙ(k), k=2,4, . . . ,M_{sc}−2, for each n=0, . . . ,Mₙₒ₋ₚₐᵢᵣₛ−1, to the corresponding subcarriers of one precoder output. Additionally, the non-paired precoder 730 maps the elements at the odd-th position of the first half of the input signal, i.e., p′ₙ(k), k=1,3, . . . ,M_{sc}−1, for each n=0, . . . ,Mₙₒ₋ₚₐᵢᵣₛ−1, to the corresponding subcarriers of another precoder output. The remaining two precoder outputs are zeros. The subcarriers at each precoder output, onto which the input signal is not mapped, are filled with zeros. For example, the TxD preceding outputs are defined by Equations 55, 56, 57 and 58:

$$\begin{matrix}{y}^{′ ( 0 )} ( {nM}_{sc} + k ) = \{ \begin{matrix}{p}_{n}^{′} ( k ) , & for k = 0 , 2 , … , {M}_{sc} - 2 \\ 0 , & otherwise .\end{matrix} & [ Eqn . 55 ] \\ {y}^{′ ( 1 )} ( {nM}_{sc} + k ) = \{ \begin{matrix}{p}_{n}^{′} ( k ) , & for k = 1 , 3 , … , {M}_{sc} - 1 , \\ 0 , & otherwise\end{matrix} & [ Eqn . 56 ] \\ {y}^{′ ( 2 )} ( {nM}_{sc} + k ) = 0 , k = 0 , … , {M}_{sc} - 1. & [ Eqn . 57 ] \\ {y}^{′ ( 3 )} ( {nM}_{sc} + k ) = 0 , k = 0 , … , {M}_{sc} - 1. & [ Eqn . 58 ]\end{matrix}$$

In Equations 55-58, n=0, . . . ,Mₙₒ₋ₚₐᵢᵣₛ−1.

In another embodiment, illustrated in FIG. 16B-(h), the non-paired precoder 730 utilizes a no-pairs H TxD preceding method 1640 to precode the no-paired sets (e.g., unpaired symbols output from pairing block 720). The non-paired precoder 730 maps the elements at every fourth position of the input signal beginning from k=0,1,2,3, to the corresponding subcarriers of four respective precoder outputs for each k. The subcarriers at each precoder output, onto which the input signal is not mapped, are filled with zeros. For example, the TxD preceding outputs are defined by Equations 59 and 60:

$$\begin{matrix}{y}^{′ ( 0 )} ( {nM}_{sc} + k ) = \{ \begin{matrix}{p}_{n}^{′} ( k ) , & for k mod 4 = 0 \\ 0 , & otherwise ,\end{matrix} \\ {y}^{′ ( 1 )} ( {nM}_{sc} + k ) = \{ \begin{matrix}{p}_{n}^{′} ( k ) , & for k mod 4 = 1 \\ 0 , & otherwise .\end{matrix} & [ Eqn . 59 ] \\ {y}^{′ ( 2 )} ( {nM}_{sc} + k ) = \{ \begin{matrix}{p}_{n}^{′} ( k ) , & for k mod 4 = 2 \\ 0 , & otherwise ,\end{matrix} \\ {y}^{′ ( 3 )} ( {nM}_{sc} + k ) = \{ \begin{matrix}{p}_{n}^{′} ( k ) , & for k mod 4 = 3 \\ 0 , & otherwise .\end{matrix} & [ Eqn . 60 ]\end{matrix}$$

In Equations 59 and 60, n=0, . . . ,Mₙₒ₋ₚₐᵢᵣₛ−1 and k=0, . . . ,M_{sc}−1.

The pair resource element mappers 745 receive one of y⁽⁰⁾(i), y⁽¹⁾(i), y⁽²⁾(i) and y⁽³⁾(i) and maps the input symbols onto the physical time-frequency grid. Similarly, the non-pair resource element mappers 740 receives one of y′⁽⁰⁾(i), y′⁽¹⁾(i), y′⁽²⁾(i) and y′⁽³⁾(i) and maps the input symbols onto the physical time-frequency grid.

In one embodiment, each of the inputs to the pair resource element mappers 745 y⁽⁰⁾(i), y⁽¹⁾(i), y⁽²⁾(i) and y⁽³⁾(i) are mapped to assigned resource elements of the antenna ports 755, respectively (e.g., antenna ports “0”, “1”, “2” and “3”, respectively). The inputs are mapped in the increasing order of subcarrier index, then in the increasing order of SC-FDMA symbol index, beginning from zero indices of assigned resources. Each of the inputs to the non-pair resource element mappers 740 y′⁽⁰⁾(i), y′⁽¹⁾(i), y′⁽²⁾(i) and y′⁽³⁾(i) are then mapped to assigned resource elements of the antenna ports 755, respectively (e.g., antenna ports “0”, “1” , “2” and “3”, respectively). The inputs are mapped in the increasing order of subcarrier index, then in the increasing order of SC-FDMA symbol index, beginning from the last indices of the mapping for the pairs.

In another embodiment, each of the inputs to the non-pair resource element mappers 740 y′⁽⁰⁾(i), y′⁽¹⁾(i), y′⁽²⁾(i) and y′⁽³⁾(i) are mapped to assigned resource elements of antenna ports 755, respectively (e.g., antenna ports “0”, “1”, “2” and “3”, respectively). The inputs are mapped in the increasing order of subcarrier index beginning from zero indices of assigned resources; each of the inputs to the pair resource element mappers 745 y⁽⁰⁾(i), y⁽¹⁾(i), y⁽²⁾(i) and y⁽³⁾(i) are then mapped to assigned resource elements of antenna ports 755, respectively (e.g., antenna ports “0”, “1”, “2” and “3”, respectively). The inputs are mapped in the increasing order of subcarrier index, then in the increasing order of SC-FDMA symbol index, beginning from the last indices of the mapping for the no-pairs.

Finally, each SC-FDMA signal generator 750 generates a SC-FDMA signal by applying inverse fast Fourier transform (IFFT) on the output of its corresponding resource element mapper 740 and 745. The output of each SC-FDMA signal generator 750 is transmitted over the air through a physical antenna 755.

4-TxD Schemes in UL Adopting SC-FDMA With Explicit Dual Carriers:

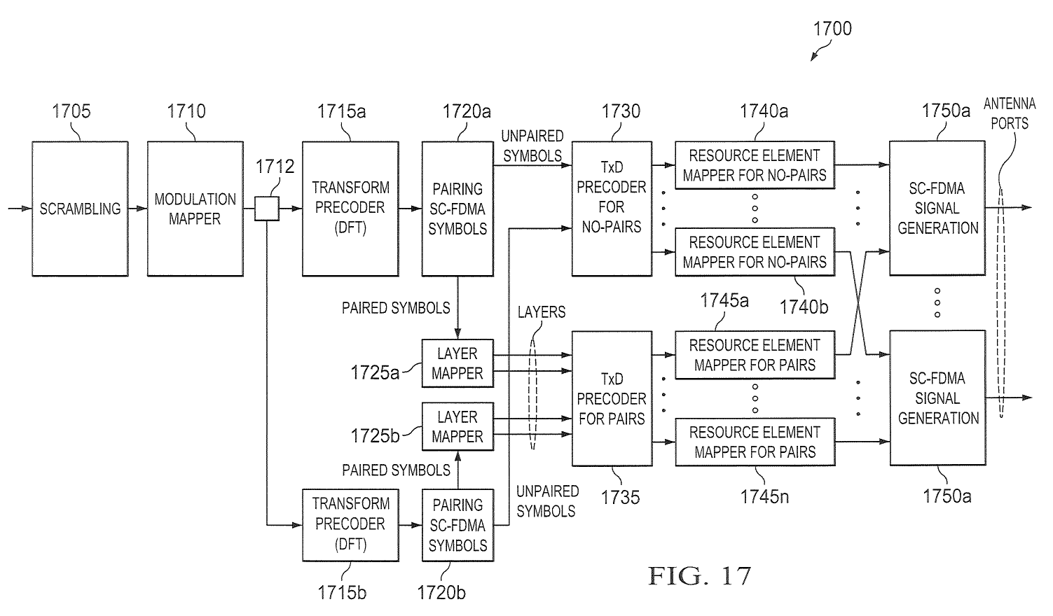

FIG. 17 illustrates a transmitter structure for 4-TxD schemes in the SC-FDMA UL with explicit dual carriers 1700 (hereinafter “dual carrier transmitter”) according to embodiments of the present disclosure. The embodiment of the dual carrier transmitter 1700 shown in FIG. 17 is for illustration only. Other embodiments of the dual carrier transmitter 1700 could be used without departing from the scope of this disclosure.

4-TxD schemes based on the 4-Tx Alamouti STBC-FSTD are designed for the SC-FDMA UL with explicit dual carrier, utilizing two DFT blocks. The dual carrier transmitter 1700 comprises a scrambling block 1705 and a modulation mapper 1710. Scrambling block 1705 and modulation mapper 1710 can be the same includes the same general structure and function as scrambling block 355 and modulation mapper 360, discussed herein above with respect to FIG. 3B. The transmitter further includes a splitter 1712, a first transform decoder 1715a, a second transform decoder 1715b, a first SC-FDMA symbol pairing block 1720a (hereinafter “first pairing block”), a second SC-FDMA symbol pairing block 1720b (hereinafter “second pairing block”) a pair of layer mappers 1725a and 1725b, a TxD precoder for non-pairs 1730 (hereinafter “non-pair precoder”), a TxD precoder for pairs 1735 (hereinafter “paired precoder”), a plurality of resource element mappers for non-pairs 1740 (hereinafter “non-pair resource element mappers”), a plurality of resource element mappers for pairs 1745 (hereinafter “pair resource element mappers”), and a plurality of SC-FDMA signal generation blocks 1750. The embodiment of the dual carrier transmitter 1700 illustrated in FIG. 17 is applicable to more than one physical channel.

Although the illustrated embodiment shows two layer mappers 1725a and 1725b, it will be understood that the operations of first layer mapper 1725a and second layer mapper 1725b may be incorporated into a single component, or multiple components, without departing from the scope of this disclosure. Furthermore, although the illustrated embodiment shows two sets of components 1740, 1745 and 1750 to generate two streams 1755a-b for transmission by two antenna ports, it will be understood that dual carrier transmitter 1700 may comprise any suitable number of component sets 1740, 1745 and 1750 based on any suitable number of streams 1755 to be generated. Further illustration of the non-paired precoder 1730 and the paired precoder 1735 as separate elements merely is by way of example. It will be understood that the operations of non-paired precoder 1730 and paired precoder 1735 may be incorporated into a single component, or multiple components, without departing from the scope of this disclosure. Further, at least some of the components in FIG. 17 may be implemented in software while other components may be implemented by configurable hardware or a mixture of software and configurable hardware.

An input to scrambling block 1705 receives a block of bits. In some embodiments, the block of bits is encoded by a channel encoder. In some embodiments, the block of bits is not encoded by a channel encoder. The scrambling block 1705 is operable to scramble the block of bits to be transmitted.

An input to the modulation mapper 1710 receives the scrambled block of bits. The dual carrier transmitter 1700 is operable to perform modulation of the scrambled bits. The modulation mapper 1710 modulates the block of scrambled bits. Modulation mapper 1710 generates a block of symbols d(l·M_{sc}+i), where l=0, . . . ,M_{SC-FDMA}−1, i=0, . . . ,M_{sc}−1, M_{SC-FDMA} is the number of SC-FDMA symbols in a time slot devoted to data transmission and M_{sc} is the number of subcarriers that SS 116 is assigned for the transmission of the symbol block. M_{sc} is a multiple of four (4). The total number of symbols within the symbol block, M_{symb}, is the product of the number of SC-FDMA symbols and the number of subcarriers, or M_{sc}·M_{SC-FDMA}.

The output of modulation mapper 1710 is split by splitter 1712. The modulated symbols are divided into two blocks of equal sizes, or M_{symb}/2=M_{SC-FDMA}M_{sc}/2 symbols, where a block of the symbols is represented by d(l·M_{sc}/2+i), i=0, . . . ,M_{sc}/2−1, and l=0, . . . ,M_{SC-FDMA}−1. The splitter 1712 sends a first block of symbols to the first transform DFT 1715a and a second block of symbols to the second transform DFT 1715b.

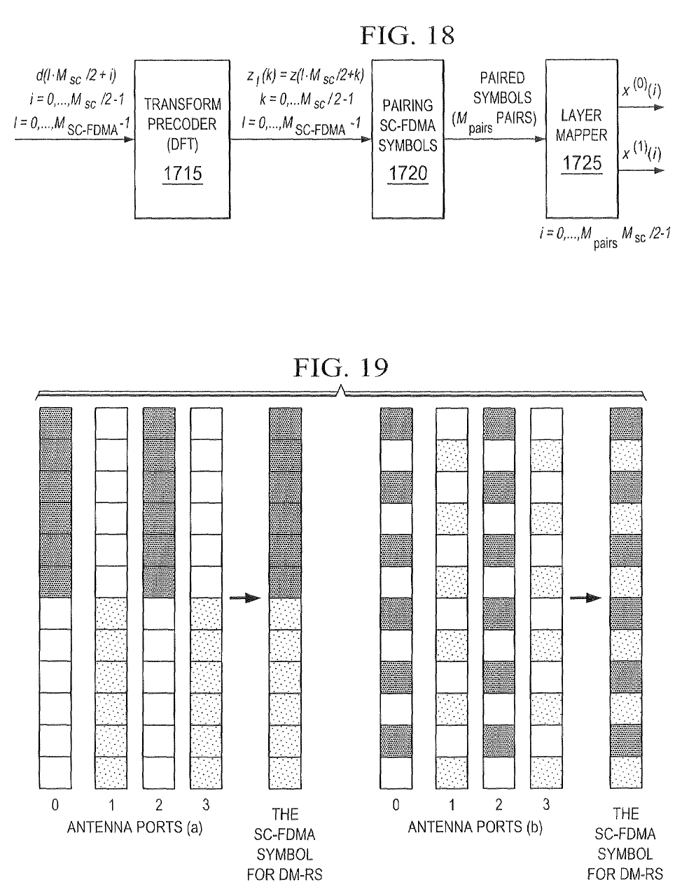

FIG. 18 illustrates a detailed view of the dual carrier transmitter components for one stream of symbols according to one embodiment of the present disclosure. The embodiment of the dual carrier transmitter components for one steam of symbols shown in FIG. 18 is for illustration only. Other embodiments of the transmitter components for one stream of symbols could be used without departing from the scope of this disclosure.

Each block of symbols separately enter a DFT block 1715; the transform preceding (or DFT) is separately performed for each block, and the subsequent processing is done separately for the two blocks, as well. The first and second pairing blocks 1720a and 1720b operate in the same or similar manner as the pairing block 720 described with respect to FIGS. 7-10 (e.g., as with the case of implicit dual carriers). The number of pairs constructed by each of the first and second pairing blocks 1720a and 1720b is denoted by Mₚₐᵢᵣₛ. Pair n is composed of two input sets, pₙ⁽⁰⁾(k) and pₙ⁽¹⁾(k), where n=0, . . . ,Mₚₐᵢᵣₛ−1 and k=0, . . . ,M_{sc}/2−1. The number of unpaired sets is denoted by Mₙₒ₋ₚₐᵢᵣₛ, and unpaired sets are denoted by p′ₙ(k), n=0, . . . ,Mₙₒ₋ₚₐᵢᵣₛ−1.

Once pairs are formed, the pairs enter the respective layer mapper 1725 from the respective pairing block 1720 (e.g., first layer mapper 1725a receives pairs from first pairing block 1720a and second layer mapper 1725b receives pairs from second pairing block 1720b). On the first layer, the first half elements in a pair are mapped; on the second layer, the second half elements in a pair are mapped. In other words, the mapping is x⁽⁰⁾(nM_{sc}/2+k)=pₙ⁽⁰⁾(k) and x⁽¹⁾(nM_{sc}/2+k)=pₙ⁽¹⁾(k), for n=0, . . . ,Mₚₐᵢᵣₛ−1 and k=0, . . . ,M_{sc}/2−1.

The four layers generated by the two separate layer mappers 1725 (e.g., first and second layer mappers 1725a and 1725b) enter into the paired precoder 1735. The paired precoder 1735 operate in the same or similar manner as the paired precoder 735 described with respect to FIGS. 7-10 (e.g., as with the case of implicit dual carriers).

The non-paired precoder 1730 first combines the two inputs generated by separate pairing blocks, and constructs a signal p′ₙ(k), for n=0, . . . ,Mₙₒ₋ₚₐᵢᵣₛ−1 and k=0, . . . ,M_{sc}−1. For example, denoting the unpaired symbols generated by the top and the bottom pairing blocks in FIG. 17 by p′ₙ⁽⁰⁾(k) and p′ₙ⁽¹⁾(k), with n=0, . . . ,Mₙₒ₋ₚₐᵢᵣₛ−1 and k=0, . . . ,M_{sc}/2−1, p′ₙ(k) is constructed according to Equation 61:

$${p}_{n}^{′} ( k ) = \{ \begin{matrix}{p}_{n}^{′ ( 0 )} ( k ) , & k = 0 , … , {M}_{sc} / 2 - 1 \\ {p}_{n}^{′ ( 1 )} ( k - {M}_{sc} / 2 ) , & k = {M}_{sc} / 2 , … {M}_{sc} - 1 ,\end{matrix} \qquad [ Eqn . 61 ]$$

In Equation 61, n=0, . . . ,Mₙₒ₋ₚₐᵢᵣₛ−1. With the input p′ₙ(k), the non-paired precoder 1730 operate in the same or similar manner as the non-paired precoder 730 described with respect to FIGS. 7-10 (e.g., as with the case of implicit dual carriers).

The resource element mappers 1740 operate in the same or similar manner as the resource element mappers 740 discussed with respect to FIGS. 7-16 (e.g., as with the case of implicit dual carriers). Further, the SC-FDMA signal generation blocks 1750 operate in the same or similar manner as the SC-FDMA signal generation blocks 750 discussed with respect to FIGS. 7-16 (e.g., as with the case of implicit dual carriers).

Demodulation Reference Signals in the 4 Transmit-Antenna System:

For the demodulation of the received signal transmitted by the four-transmit-antenna transmitters, the channels between each transmit antenna and a receive antenna are separately measured utilizing dedicated pilots. To facilitate the separate measurement of reference signals at a UE, the reference signals are transmitted in orthogonal dimensions.

FIG. 19 illustrates a DM-RS mapping method according to embodiments of the present disclosure. The embodiment of the DM-RS mapping method shown 1900 in FIG. 19 is for illustration only. Other embodiments of the DM-RS mapping method 1900 could be used without departing from the scope of this disclosure.

A first method is assigning two DM-RS CSs and one SC-FDMA symbol for the DM-RS. In such method, two reference sequences are constructed for the four antenna ports. A different cyclic shift (CS) is assigned, as defined in Equation 12, to each of the two references sequences defined in Equation 9 such that the two references signals are orthogonal to each other. Two DM-RS CS indices are denoted by n_{DMRS,0}⁽²⁾ and n_{DMRS,1}⁽²⁾, and their corresponding CSs are denoted by α₀ and α₁. Thereafter, the base station 102 transmits a control message containing information on the two CSs to SS 116.

In one embodiment, (denoted by DM-RS Indication A), the base station 102 explicitly informs CSs to a scheduled SS 116 by sending different DM-RS CS indices, n_{DMRS,0}⁽²⁾ and n_{DMRS,1}⁽²⁾, to SS 116 with a scheduling grant (or downlink control information (DCI) format “0” in GPP LTE 36.212). For this explicit indication, a secondary CS field is added to the existing DCI format “0”, a new DCI format with two (2) CS fields can be created.

In another embodiment, (denoted by DM-RS Indication B), the base station 102 implicitly informs CSs to a scheduled SS 116 by sending only one DM-RS CS index, n_{DMRS,0}⁽²⁾, to SS 116 with the scheduling grant. For this implicit indication, the existing DCI format “0” can be used. At SS 116, n_{DMRS,1}⁽²⁾ is obtained from a relation between n_{DMRS,0}⁽²⁾ and n_{DMRS,1}⁽²⁾. In one example, the relation is defined by Equation 62:

n_{DMRS,1}⁽²⁾=(n_{DMRS,0}⁽²⁾+6)mod 12. [Eqn. 62]

Then, two reference sequences are constructed with the two DM-RS CS indices, n_{DMRS,0}⁽²⁾ and n_{DMRS,1}⁽²⁾ where the length of each sequence is equal to half the number of the assigned subcarriers, or M_{sc}/2. Applying Equation 12 with n_{DMRS,0}⁽²⁾ and n_{DMRS,1}⁽²⁾, the two CSs are obtained: α₀ and α₁. Then, the two reference sequences are defined by Equations 63 and 64:

r_{u,v}^{(α}^{₀}⁾(n)=e^{jα}^{₀}ⁿ r̅_{u,v}(n), 0≦n<M_{sc}/2. [Eqn. 63]

r_{u,v}^{(α}^{₁}⁾(n)=e^{jα}^{₁}ⁿ r̅_{u,v}(n), 0≦n<M_{sc}/2. [Eqn. 64]

DM-RS sequences for two physical antenna ports are constructed by one of the these reference signal sequences, while reference signal sequences for the other two physical antenna ports are constructed by the other reference sequence.

In one embodiment, (denoted by DM-RS Sequence Construction A: top-down split with two RS sequences), the two reference signal sequences are mapped onto the first half elements at each SC-FDMA symbol on the sequences for antenna ports “0” and “2”, respectively. Additionally, the two reference signal sequences are mapped onto the last half elements at each SC-FDMA symbol on the sequences for antenna ports “1” and “3”, respectively. For example, the demodulation reference signal sequence for antenna port p is denoted by rₚ(·) for p=0,1,2,3 and is constructed by Equations 65, 66, 67 and 68:

$$\begin{matrix}{r}_{0} ( m \cdot {M}_{sc} + n ) = \{ \begin{matrix}{r}_{u , v}^{( {α}_{0} )} ( n ) , & n = 0 , … , {M}_{sc} / 2 - 1 \\ 0 , & n = {M}_{sc} / 2 , … {M}_{sc} - 1.\end{matrix} & [ Eqn . 65 ] \\ {r}_{2} ( m \cdot {M}_{sc} + n ) = \{ \begin{matrix}{r}_{u , v}^{( {α}_{1} )} ( n ) , & n = 0 , … , {M}_{sc} / 2 - 1 \\ 0 , & n = {M}_{sc} / 2 , … {M}_{sc} - 1.\end{matrix} & [ Eqn . 66 ] \\ {r}_{1} ( m \cdot {M}_{sc} + n ) = \{ \begin{matrix}0 , & n = 0 , … , {M}_{sc} / 2 - 1 \\ {r}_{u , v}^{( {α}_{0} )} ( n - {M}_{sc} / 2 ) , & n = {M}_{sc} / 2 , … {M}_{sc} - 1.\end{matrix} & [ Eqn . 67 ] \\ {r}_{3} ( m \cdot {M}_{sc} + n ) = \{ \begin{matrix}0 , & n = 0 , … , {M}_{sc} / 2 - 1 \\ {r}_{u , v}^{( {α}_{1} )} ( n - {M}_{sc} / 2 ) , & n = {M}_{sc} / 2 , … {M}_{sc} - 1.\end{matrix} & [ Eqn . 68 ]\end{matrix}$$

In Equations 65-68, m=0,1 is the slot index. This mapping is illustrated in FIG. 19-(a).

In another embodiment, denoted by DM-RS Sequence Construction B: even-odd split with two RS sequences, the two reference signal sequences are mapped onto the even-th elements at each SC-FDMA symbol on the sequences for antenna ports “0” and “2” respectively. Additionally, the two reference signal sequences are mapped onto the odd-th elements at each SC-FDMA symbol on the sequences for antenna ports “1” and “3” respectively. For example, the demodulation reference signal sequence for antenna port p is denoted by rₚ(·) for p=0,1,2,3 and is constructed by Equations 69, 70, 71 and 72:

$$\begin{matrix}{r}_{0} ( m \cdot {M}_{sc} + n ) = \{ \begin{matrix}{r}_{u , v}^{( {α}_{0} )} ( n / 2 ) , & n is even \\ 0 , & n is odd .\end{matrix} & [ Eqn . 69 ] \\ {r}_{2} ( m \cdot {M}_{sc} + n ) = \{ \begin{matrix}{r}_{u , v}^{( {α}_{1} )} ( n / 2 ) , & n is even \\ 0 , & n is odd .\end{matrix} & [ Eqn . 70 ] \\ {r}_{1} ( m \cdot {M}_{sc} + n ) = \{ \begin{matrix}0 , & n is even \\ {r}_{u , v}^{( {α}_{0} )} ( ( n - 1 ) / 2 ) , & n is odd .\end{matrix} & [ Eqn . 71 ] \\ {r}_{3} ( m \cdot {M}_{sc} + n ) = \{ \begin{matrix}0 , & n is even \\ {r}_{u , v}^{( {α}_{1} )} ( ( n - 1 ) / 2 ) , & n is odd .\end{matrix} & [ Eqn . 72 ]\end{matrix}$$

In Equations 69-72, m=0,1 is the slot index and n=0, . . . ,M_{sc}−1. This mapping is depicted in FIG. 19-(b).

Then, the sequence rₚ(·) shall be multiplied with the amplitude scaling factor β and mapped in sequence starting with rₚ(0) to the set of physical resources for antenna port p assigned for DM-RS transmission. The mapping to resource elements in the subframe is in increasing order of first the subcarrier index, then the slot number.

In the uplink transmission, SS 116 maps both reference signal sequences in the same or similar manner as an LTE UE.

A second method is Assigning two DM-RS CSs and two SC-FDMA symbols for the DM-RS. In this method, two reference sequences are constructed for the four antenna ports. Different CS's, defined in Equation 12, are assigned to each of the two reference sequences, defined in Equation 9, such that the two reference sequences are orthogonal to each other. Two DM-RS CS indices are denoted by n_{DMRS,0}⁽²⁾ and n_{DMRS,1}⁽²⁾ and their corresponding CSs are denoted by α₀ and α₁. The two DM-RS CSs are sent to SS 116 in the same or similar manner as for Method 1, described hereinabove. Two SC-FDMA symbols are reserved for DM-RS. In some embodiments, the location of the DM-RS SC-FDMA symbols is dependent on the cyclic-prefix length.

In one embodiment, the third and the fourth SC-FDMA symbols in a time slot (or SC-FDMA symbols “2” and “3”, when the indices start from “0”) are assigned for the DM-RS.

In another embodiment, the second and the third SC-FDMA symbols in a time slot (or SC-FDMA symbols “1” and “2”, when the indices start from “0”) are assigned for the DM-RS.

Two reference sequences are constructed with the two DM-RS CS indices, n_{DMRS,0}⁽²⁾ and n_{DMRS,1}⁽²⁾ where the length of each sequence is equal to the number of the assigned subcarriers, or M_{sc}. Applying Equation 12, with n_{DMRS,0}⁽²⁾ and n_{DMRS,1}⁽²⁾, the two CSs are obtained: α₀ and α₁. Then, the two reference sequences are defined by Equations 73 and 74:

r_{u,v}^{(α}^{₀}⁾(n)=e^{jα}^{₀}ⁿ r̅_{u,v}(n), 0≦n<M_{sc}. [Eqn. 73]

r_{u,v}^{(α}^{₁}⁾(n)=e^{jα}^{₁}ⁿ r̅_{u,v}(n), 0≦n<M_{sc}. [Eqn. 74]

Construction of reference signal sequences for antenna ports: DM-RS sequences for two physical antenna ports are constructed by one of the reference signal sequences. Additionally, the reference signal sequences for the other two physical antenna ports are constructed by the other reference sequence. Then, the antenna ports are paired. One pair is mapped to the subcarriers in one SC-FDMA symbol assigned for DM-RS, while the other pair is mapped to the subcarriers in the other SC-FDMA symbol assigned for DM-RS.

In one embodiment, the DM-RS sequences for the first and the third antenna ports (or antenna ports “0” and “2”, when indexed from “0”) are constructed by one reference signal sequence. Additionally, the DM-RS sequences for the second and the fourth antenna ports (or antenna ports “1” and “3”, when indexed from “0”) are constructed by the other reference signal sequence. For example, the demodulation reference signal sequence for antenna port p is denoted by rₚ(·) for p=0,1,2,3 and is constructed by Equations 75, 76, 77 and 78:

r₀(m·M_{sc}+n)=r_{u,v}^{(α}^{₀}⁾(n),n=0, . . . ,M_{sc}. [Eqn. 75]

r₂(m·M_{sc}+n)=r_{u,v}^{(α}^{₀}⁾(n),n=0, . . . ,M_{sc}. [Eqn. 76]

r₁(m·M_{sc}+n)=r_{u,v}^{(α}^{₁}⁾(n),n=0, . . . ,M_{sc}. [Eqn. 77]

r₃(m·M_{sc}+n)=r_{u,v}^{(α}^{₁}⁾(n),n=0, . . . ,M_{sc}. [Eqn. 78]

In Equations 75-78, m=0,1 is the slot index.

In another embodiment, the DM-RS sequences for the first and the second antenna ports (or antenna ports “0” and “1”, when indexed from “0”) are constructed by one reference signal sequence. Additionally, the DM-RS sequences for the third and the fourth antenna ports (or antenna ports “2” and “3”, when indexed from “0”) are constructed by the other reference signal sequence. For example, the demodulation reference signal sequence for antenna port p is denoted by rₚ(·) for p=0,1,2,3 and is constructed by Equations 79, 80, 81 and 82:

r₀(m·M_{sc}+n)=r_{u,v}^{(α}^{₀}⁾(n),n=0, . . . ,M_{sc}. [Eqn. 79]

r₂(m·M_{sc}+n)=r_{u,v}^{(α}^{₁}⁾(n),n=0, . . . ,M_{sc}. [Eqn. 80]

r₁(m·M_{sc}+n)=r_{u,v}^{(α}^{₀}⁾(n),n=0, . . . ,M_{sc}. [Eqn. 81]

r₃(m·M_{sc}+n)=r_{u,v}^{(α}^{₁}⁾(n),n=0, . . . ,M_{sc}. [Eqn. 82]

In Equations 79-82, m=0,1 is the slot index.

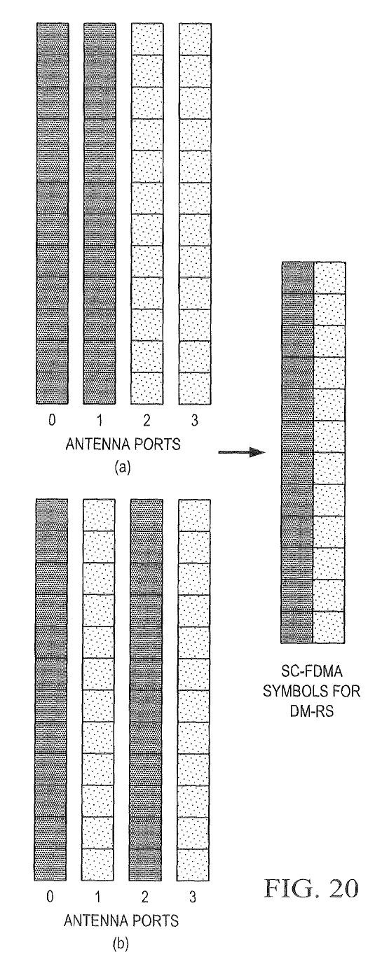

FIG. 20 illustrates another DM-RS mapping method according to embodiments of the present disclosure. The embodiment of the DM-RS mapping method shown 2000 in FIG. 20 is for illustration only. Other embodiments of the DM-RS mapping method 2000 could be used without departing from the scope of this disclosure.

The four DM-RS sequences for the four antenna ports are paired, and two pairs are formed. Each pair is mapped onto each of the SC-FDMA symbols assigned for the DM-RS. Examples of pair forming are illustrated in FIG. 20. In FIG. 20-(a), antenna ports “0” and “1” (and “2” and “3”) form a pair and are mapped to an SC-FDMA symbol for DM-RS, where the DM-RS sequences in antenna ports “0” and “1” (and “2” and “3”) are distinctly formed by different DM-RS CSs. In FIG. 20-(b), antenna ports “0” and “2” (and “1” and “3”) form a pair and mapped to an SC-FDMA symbol for DM-RS, where the DM-RS sequences in antenna ports “0” and “2” (and “1” and “3”) are distinctly formed by different DM-RS CSs.

In one embodiment, the sequence rₚ(·) shall be multiplied with the amplitude scaling factor β. Then, rₚ(·), p=0,1, is mapped in sequence starting with rₚ(0) to the set of subcarriers in the first DM-RS SC-FDMA symbol for antenna port p assigned for DM-RS transmission. Additionally, rₚ(·), p=2,3, is mapped in sequence starting with rₚ(0) to the set of subcarriers in the second DM-RS SC-FDMA symbol for antenna port p assigned for DM-RS transmission. This mapping is shown in FIG. 20-(a). The mapping to resource elements in the subframe is in increasing order of first the subcarrier index, then the slot number.

In another embodiment, the sequence rₚ(·) shall be multiplied with the amplitude scaling factor β. Then, rₚ(·), p=0,2, is mapped in sequence starting with rₚ(0) to the set of subcarriers in the first DM-RS SC-FDMA symbol for antenna port p assigned for DM-RS transmission. Further, rₚ(·), p=1,3, is mapped in sequence starting with rₚ(0) to the set of subcarriers in the second DM-RS SC-FDMA symbol for antenna port p assigned for DM-RS transmission. This mapping is illustrated in FIG. 20-(b). The mapping to resource elements in the subframe is in increasing order of first the subcarrier index, then the slot number.

A third Method is assigning four DM-RS CSs and one SC-FDMA symbol for the DM-RS. In this method, four reference sequences are constructed for the four antenna ports. Different cyclic shifts (CSs), defined in Equation 12, are assigned to each of the two reference sequences, defined in Equation 9, such that the two reference sequences are orthogonal to each other. Four DM-RS CS indices are denoted by n_{DMRS,0}⁽²⁾, n_{DMRS,1}⁽²⁾, n_{DMRS,2}⁽²⁾, and n_{DMRS,3}⁽²⁾ and their corresponding CSs are denoted by α₀, α₁, α₂ and α₃. The four DM-RS CSs are sent to SS 116 (e.g. informs SS 116) as in the same or similar manner as for the first Method, discussed with respect to FIG. 19.

In one embodiment, the base station 102 explicitly sends (informs) CSs to a scheduled SS 116 by sending four different DM-RS CS indices to SS 116 with the scheduling grant. For this explicit indication, three additional CS fields are added to the existing DCI format “0”, a new DCI format with four CS fields can be created.

In another embodiment, the base station 102 implicitly sends (informs) CSs to a scheduled SS 116 by sending only one DM-RS CS index, n_{DMRS,0}⁽²⁾, to SS 116 with the scheduling grant. For this implicit indication, the existing DCI format “0” can be used. At SS 116, n_{DMRS,1}⁽²⁾, n_{DMRS,2}⁽²⁾ and n_{DMRS,3}⁽²⁾ are obtained from a relation between n_{DMRS,0}⁽²⁾, n_{DMRS,1}⁽²⁾, n_{DMRS,2}⁽²⁾ and n_{DMRS,3}⁽²⁾. In one example, the relation is defined by Equations 83, 84 and 85:

n_{DMRS,1}⁽²⁾=(n_{DMRS,0}⁽²⁾+3)mod 12. [Eqn. 83]

n_{DMRS,2}⁽²⁾=(n_{DMRS,0}⁽²⁾+6)mod 12. [Eqn. 84]

n_{DMRS,3}⁽²⁾=(n_{DMRS,0}⁽²⁾+9)mod 12. [Eqn. 85]

In such embodiments, the generation of reference signal sequences is accomplished wherein four reference sequences are constructed with the four DM-RS CS indices, n_{DMRS,0}⁽²⁾, n_{DMRS,1}⁽²⁾, n_{DMRS,2}⁽²⁾ and n_{DMRS,3}⁽²⁾, where the length of each sequence is equal to the number of the assigned subcarriers, or M_{sc}. Applying Equation 12 with the DM-RS CS indices, four CSs are obtained: α₀, α₁, α₂ and α₃. Then, the four reference sequences are defined by Equations 86, 87, 88 and 89:

r_{u,v}^{(α}^{₀}⁾(n)=e^{jα}^{₀}ⁿ r̅_{u,v}(n), 0≦n<M_{sc}. [Eqn. 86]

r_{u,v}^{(α}^{₁}⁾(n)=e^{jα}^{₁}ⁿ r̅_{u,v}(n), 0≦n<M_{sc}. [Eqn. 87]

r_{u,v}^{(α}^{₂}⁾(n)=e^{jα}^{₂}ⁿ r̅_{u,v}(n), 0≦n<M_{sc}. [Eqn. 88]

r_{u,v}^{(α}^{₃}⁾(n)=e^{jα}^{₃}ⁿ r̅_{u,v}(n), 0≦n<M_{sc}. [Eqn. 89]

Construction of reference signal sequences for antenna ports: the four reference signal sequences are used to construct four DM-RS sequences for the four physical antenna ports. For example, the DM-RS sequence for antenna port p is denoted by rₚ(·) for p=0,1,2,3 and is constructed by Equations 89, 90, 91 and 92:

r₀(m·M_{sc}+n)=r_{u,v}^{(α}^{₀}⁾(n),n=0, . . . ,M_{sc}. [Eqn. 89]

r₂(m·M_{sc}+n)=r_{u,v}^{(α}^{₂}⁾(n),n=0, . . . ,M_{sc}. [Eqn. 90]

r₁(m·M_{sc}+n)=r_{u,v}^{(α}^{₁}⁾(n),n=0, . . . ,M_{sc}. [Eqn. 91]

r₃(m·M_{sc}+n)=r_{u,v}^{(α}^{₃}⁾(n),n=0, . . . ,M_{sc}. [Eqn. 92]

In Equations 89-92, m=0,1 is the slot index.

The sequence rₚ(·) shall be multiplied with the amplitude scaling factor β and mapped in sequence starting with rₚ(0) to the set of physical resources for antenna port p assigned for DM-RS transmission. The mapping to resource elements in the subframe is in increasing order of first the subcarrier index, then the slot number.

A fourth Method is assigning one DM-RS CS and one SC-FDMA symbol for the DM-RS. In the fourth method, one reference sequence is constructed for the four antenna ports. One CS is assigned to the reference sequence. The DM-RS CS index is denoted by n_{DMRS}⁽²⁾. The four reference signals for the four antenna ports are separated in an FDM manner.

The base station 102 transmits a control message containing the CS to SS 116. This can be done by base station 102 sending the LTE's existing DCI format “0” to SS 116.

Generation of reference signal sequences: a reference sequence is constructed with the DM-RS CS index, n_{DMRS}⁽²⁾ where the length of the sequence is equal to quarter the number of the assigned subcarriers, or M_{sc}/4. Applying Equation 12 with n_{DMRS}⁽²⁾, a CS α is obtained. Then, the reference sequence is constructed as defined by Equation 93:

r_{u,v}^{(α)}(n)=e^{jαn} r̅_{u,v}(n), 0≦n<M_{sc}/4. [Eqn. 93]

Construction of reference signal sequences for antenna ports: reference signal sequences for the four antenna ports are constructed by the reference signal sequence, such that the reference sequence is mapped to the resource elements of each of the four antenna ports in an FDM manner.

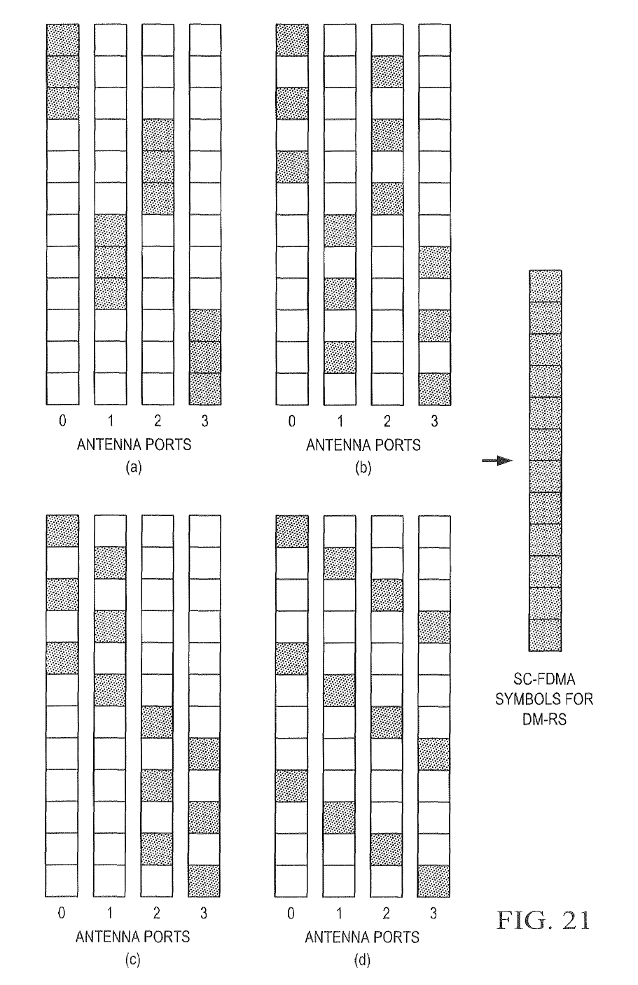

FIG. 21 illustrates another DM-RS mapping method according to embodiments of the present disclosure. The embodiment of the DM-RS mapping method shown 2100 in FIG. 21 is for illustration only. Other embodiments of the DM-RS mapping method 2100 could be used without departing from the scope of this disclosure.

In one embodiment, for an antenna port, the reference signal sequence is mapped onto a quarter of the frequency resources in the increasing order of subcarrier index, then slot index. For example, the reference signal sequences for antenna ports are defined by Equations 94, 95, 96 and 97:

$$\begin{matrix}{r}_{0} ( m \cdot {M}_{sc} + n ) = \{ \begin{matrix}{r}_{u , v}^{( α )} ( n ) , & n = 0 , … , {M}_{sc} / 4 - 1 \\ 0 , & n = {M}_{sc} / 4 , … , {M}_{sc} - 1.\end{matrix} & [ Eqn . 94 ] \\ {r}_{1} ( m \cdot {M}_{sc} + n ) = \{ \begin{matrix}{r}_{u , v}^{( α )} ( n - {M}_{sc} / 2 ) , & n = {M}_{sc} / 2 , … , 3 {M}_{sc} / 4 - 1 \\ 0 , & \begin{matrix}n = 0 , … , {M}_{sc} / 2 - 1 , \\ or n = 3 {M}_{sc} / 4 , … , {M}_{sc} - 1.\end{matrix} \end{matrix} & [ Eqn . 95 ] \\ {r}_{2} ( m \cdot {M}_{sc} + n ) = \{ \begin{matrix}{r}_{u , v}^{( α )} ( n - {M}_{sc} / 4 ) , & n = {M}_{sc} / 4 , … , {M}_{sc} / 2 - 1 \\ 0 , & \begin{matrix}n = 0 , … , {M}_{sc} / 4 - 1 , \\ or n = {M}_{sc} / 2 , … , {M}_{sc} - 1.\end{matrix} \end{matrix} & [ Eqn . 96 ] \\ {r}_{3} ( m \cdot {M}_{sc} + n ) = \{ \begin{matrix}{r}_{u , v}^{( α )} ( n - 3 {M}_{sc} / 4 ) , & n = 3 {M}_{sc} / 4 , … , {M}_{sc} - 1 \\ 0 , & n = 0 , … , 3 {M}_{sc} / 4 - 1.\end{matrix} & [ Eqn . 97 ]\end{matrix}$$

In Equations 94-97, m=0,1 is the slot index. The frequency resources at antenna ports assigned by this resource are shown in FIG. 21-(a).

In another embodiment, for an antenna port, the reference signal sequence is mapped onto one of the following sets of frequency resources: the even-th resources of the first half of the frequency resources; the odd-th resources of the first half of the frequency resources; the even-th resources of the last half of the frequency resources; and the odd-th resources of the last half of the frequency resources. For example, the outputs of the TxD precoders 1730, 1735 are defined by Equations 98, 99, 100 and 101:

$$\begin{matrix}{r}_{0} ( m \cdot {M}_{sc} + n ) = \{ \begin{matrix}{r}_{u , v}^{( α )} ( n / 2 ) , & n = 0 , 2 , … , {M}_{sc} / 2 - 2 \\ 0 , & otherwise .\end{matrix} & [ Eqn . 98 ] \\ {r}_{1} ( m \cdot {M}_{sc} + n ) = \{ \begin{matrix}{r}_{u , v}^{( α )} ( ( n - {M}_{sc} / 2 ) / 2 ) , & \begin{matrix}n = {M}_{sc} / 2 , {M}_{sc} / \\ 2 + 2 , … , {M}_{sc} 2 - 1\end{matrix} \\ 0 , & otherwise .\end{matrix} & [ Eqn . 99 ] \\ {r}_{2} ( m \cdot {M}_{sc} + n ) = \{ \begin{matrix}{r}_{u , v}^{( α )} ( ( n - 1 ) / 2 ) , & n = 1 , 3 , … , {M}_{sc} / 2 - 1 \\ 0 , & otherwise .\end{matrix} & [ Eqn . 100 ] \\ {r}_{3} ( m \cdot {M}_{sc} + n ) = \{ \begin{matrix}{r}_{u , v}^{( α )} ( ( n - {M}_{sc} / 2 - 1 ) / 2 ) , & \begin{matrix}n = {M}_{sc} / 2 + 1 , {M}_{sc} / \\ 2 + 3 , … , {M}_{sc} - 1\end{matrix} \\ 0 , & otherwise .\end{matrix} & [ Eqn . 101 ]\end{matrix}$$

In Equations 98-101, m=0,1 is the slot index and n=0, . . . ,M_{sc}−1. The frequency resources at antenna ports assigned by this resource are shown in FIG. 21-(b). In another example, the outputs of the TxD precoders 1730, 1735 are defined by Equations 102, 103, 104 and 105:

$$\begin{matrix}{r}_{0} ( m \cdot {M}_{sc} + n ) = \{ \begin{matrix}{r}_{u , v}^{( α )} ( n / 2 ) , & n = 0 , 2 , … , {M}_{sc} / 2 - 2 \\ 0 , & otherwise .\end{matrix} & [ Eqn . 102 ] \\ {r}_{1} ( m \cdot {M}_{sc} + n ) = \{ \begin{matrix}{r}_{u , v}^{( α )} ( ( n - 1 ) / 2 ) , & n = 1 , 3 , … , {M}_{sc} / 2 - 1 \\ 0 , & otherwise .\end{matrix} & [ Eqn . 103 ] \\ {r}_{2} ( m \cdot {M}_{sc} + n ) = \{ \begin{matrix}{r}_{u , v}^{( α )} ( ( n - {M}_{sc} / 2 ) / 2 ) , & \begin{matrix}n = {M}_{sc} / 2 , {M}_{sc} / \\ 2 + 2 , … , {M}_{sc} - 2\end{matrix} \\ 0 , & otherwise .\end{matrix} & [ Eqn . 104 ] \\ {r}_{3} ( m \cdot {M}_{sc} + n ) = \{ \begin{matrix}{r}_{u , v}^{( α )} ( ( n - {M}_{sc} / 2 - 1 ) / 2 ) , & \begin{matrix}n = {M}_{sc} / 2 + 1 , {M}_{sc} / \\ 2 + 3 , … , {M}_{sc} - 1\end{matrix} \\ 0 , & otherwise .\end{matrix} & [ Eqn . 105 ]\end{matrix}$$

In Equations 102-105, m=0,1 is the slot index and n=0, . . . ,M_{sc}−1. The frequency resources at antenna ports assigned by this resource are shown in FIG. 21-(c).

In another embodiment, for an antenna port, the reference signal sequence is mapped onto a set of frequency resources at every fourth position from one of the subcarrier indices k=0,1,2,3. For example, the outputs of the TxD precoders 1730, 1735 are defined by Equations 106, 107, 108 and 109:

$$\begin{matrix}{r}_{0} ( m \cdot {M}_{sc} + n ) = \{ \begin{matrix}{r}_{u , v}^{( α )} ( n / 4 ) , & for k mod 4 = 0 \\ 0 , & otherwise .\end{matrix} & [ Eqn . 106 ] \\ {r}_{1} ( m \cdot {M}_{sc} + n ) = \{ \begin{matrix}{r}_{u , v}^{( α )} ( ( n - 1 ) / 4 ) , & for k mod 4 = 1 \\ 0 , & otherwise .\end{matrix} & [ Eqn . 107 ] \\ {r}_{2} ( m \cdot {M}_{sc} + n ) = \{ \begin{matrix}{r}_{u , v}^{( α )} ( ( n - 2 ) / 4 ) , & for k mod 4 = 2 \\ 0 , & otherwise .\end{matrix} & [ Eqn . 108 ] \\ {r}_{3} ( m \cdot {M}_{sc} + n ) = \{ \begin{matrix}{r}_{u , v}^{( α )} ( ( n - 3 ) / 4 ) , & for k mod 4 = 3 \\ 0 , & otherwise .\end{matrix} & [ Eqn . 109 ]\end{matrix}$$

In Equations 106-109, m=0,1 is the slot index and n=0, . . . ,M_{sc}−1. The frequency resources at antenna ports assigned by this resource is shown in FIG. 21-(d).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communications network, a subscriber station capable of diversity transmissions, the subscriber station comprising:
a pairing device configured to pair a number of symbol sets to form a number of paired sets, wherein the pairing device pairs a first symbol set with a second symbol set to form a paired set;
a layer mapper configured to map the number of paired sets onto a number of layers;
a transmit diversity precoder configured to precode the number of layers into at least two pairs of two precoded streams; and
a resource element mapper configured to map each pair of the precoded streams onto at least two antenna ports.

2. The subscriber station as set forth in claim 1, wherein the resource element mapper uses at least one of a top-down split method and an even-odd split method.

3. The subscriber station as set forth in claim 2, wherein the transmit diversity precoder is configured to precode at least a portion of the layers using an Alamouti space time-block code.

4. The subscriber station as set forth in claim 1, further comprising a signal generator configured to map a first number of demodulation reference signals onto a portion of resource elements allocated for the transmission of demodulation reference signals and a second number of demodulation reference signals onto another portion of the resource elements.

5. The subscriber station as set forth in claim 4, wherein said signal generator is further configured to at least one of:
assign a first number of demodulation reference signals to a top half subcarrier resource element set and a second number of demodulation reference signals to a bottom half subcarrier resource element set; and
assign a first number of demodulation reference signals to an even half subcarrier resource element set and a second number of demodulation reference signals to an odd half subcarrier resource element set.

6. The subscriber station as set forth in claim 4, wherein said signal generator is further configured to multiplex the number of demodulation reference signals within a resource element set using code division multiplexing.

7. The subscriber station as set forth in claim 4, wherein a first number of demodulation reference signals are transmitted in a first symbol and a second number of demodulation reference signals are transmitted in a second symbol.

8. A subscriber station capable of diversity transmissions, the subscriber station comprising:
a dual carrier transmitter, the dual carrier transmitter comprising;
a modulation device,
a precoding device, and
a pairing device configured to pair a number of symbols sets to form at least one paired set, wherein the pairing device pairs a first symbol set with a second symbol set to form the at least one paired set; and
a layer mapper configured to map the number of paired sets onto a number of layers;
a transmit diversity precoder configured to precode the number of layers into at least two pairs of two precoded streams; and
a resource element mapper configured to map each pair of the precoded streams onto at least two antenna ports.

9. The subscriber station as set forth in claim 8, wherein the preceding device comprises a first transform precoder and a second transform precoder, the pairing device comprises a first pairing block and a second pairing block, and wherein a first stream of symbol sets is precoded through the first transform precoder and paired through the first pairing block and a second stream of symbol sets is precoded through the second transform precoder and paired through second pairing block.

10. The subscriber station as set forth in claim 8 wherein the layer mapper is configured to map the at least one paired set onto a number of layers using at least one of a top-down split method and an even-odd split method.

11. The subscriber station as set forth in claim 10, wherein the transmit diversity precoder is configured to precode at least a portion of the layers using an Alamouti space time-block code.

12. The subscriber station as set forth in claim 8, wherein the subscriber station further comprises a signal generator configured to map a first number of demodulation reference signals onto a portion of resource elements allocated for the transmission of demodulation reference signals and a second number of demodulation reference signals onto another portion of the resource elements.

13. The subscriber station as set forth in claim 12, wherein said signal generator is further configured to at least one of:
assign a first number of demodulation reference signals to a top half subcarrier resource element set and a second number of demodulation reference signals to a bottom half subcarrier resource element set; and
assign a first number of demodulation reference signals to an even half subcarrier resource element set and a second number of demodulation reference signals to an odd half subcarrier resource element set.

14. The subscriber station as set forth in claim 12, wherein said signal generator further is configured to assign the number of demodulation reference signals within a resource element set using code division multiplexing.

15. The subscriber station as set forth in claim 12, wherein a first number of demodulation reference signals are transmitted in a first symbol and a second number of demodulation reference signals are transmitted in a second symbol.

16. For use in a wireless communications network capable of multiple input multiple output transmissions, a method for transmitting demodulation reference signals, the method comprising:
transmitting a number demodulation reference signals via a portion of a number of resource elements for at least two antenna ports, wherein a first number of demodulation reference signals are transmitted via a portion of the resource elements allocated for the transmission of demodulation reference signals and a second number of demodulation reference signals are transmitted via another portion of the resource elements.

17. The method as set forth in claim 16, wherein the first number of demodulation reference signals are transmitted via a top half of the resource elements and the second number of demodulation reference signals are transmitted via a bottom half of the resource elements.

18. The method as set forth in claim 16, wherein the first number of demodulation reference signals are transmitted via an even half of the resource elements and the second number of demodulation reference signals are transmitted via an odd half of the resource elements.

19. The method as set forth in claim 16, wherein the number of demodulation reference signals within a resource element set are multiplexed using code division multiplexing.

20. The method as set forth in claim 16, wherein a first number of demodulation reference signals are transmitted in a first symbol and a second number of demodulation reference signals are transmitted in a second symbol.
